(19) United States
(12) Patent Application Publication
(10) Pub. No.: US 2024/0097206 A1
(43) Pub. Date: Mar. 21, 2024

(54) INTEGRATED SHEET STRUCTURE, SECONDARY BATTERY, AQUEOUS SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Hirofumi YASUMIISHI, Kawasaki Kanagawa (JP); Keigo HOSHINA, Yokohama Kanagawa (JP); Yasuyuki HOTTA, Ota Tokyo (JP); Yumiko SEKIGUCHI, Kawasaki Kanagawa (JP); Kazuomi YOSHIMA, Yokohama Kanagawa (JP); Hayato SEKI, Kawasaki Kanagawa (JP); Wataru UNO, Yokohama Kanagawa (JP)

(73) Assignee: KABUSHIKI KAISHA TOSHIBA, Tokyo (JP)

(21) Appl. No.: 18/240,500

(22) Filed: Aug. 31, 2023

(30) Foreign Application Priority Data
Sep. 16, 2022 (JP) 2022-148155

(51) Int. Cl. H01M 10/38; H01M 4/485; H01M 4/505; H01M 4/62; H01M 50/414; H01M 50/431; H01M 50/443; H01M 50/446; H01M 50/46

(52) U.S. Cl. CPC H01M 10/38; H01M 4/485; H01M 4/505; H01M 4/622; H01M 50/414; H01M 50/431; H01M 50/443; H01M 50/446; H01M 50/46; H01M 2004/027

(57) ABSTRACT

An integrated sheet structure for a secondary battery, including a first mixture layer containing a first active material and a first binder, a second mixture layer containing a second active material and a second binder, and a third mixture layer located between the first mixture layer and the second mixture layer and containing solid particles and a third binder, in which the first mixture layer and the third mixture layer are bonded each other, and the second mixture layer and the third mixture layer are bonded each other.

### CROSS-REFERENCE TO RELATED APPLICATIONS

This application is based upon and claims the benefit of priority from Japanese Patent Application No. 2022-148155 filed on Sep. 16, 2022, and the entire contents of which are incorporated herein by reference.

### FIELD

Embodiments described herein relate generally to an integrated sheet structure, a secondary battery, an aqueous secondary battery, a battery pack, a vehicle, and a stationary power supply.

### BACKGROUND

A non-aqueous electrolyte battery such as a secondary battery is used as a power supply in a broad field.

The forms of non-aqueous electrolyte batteries include many different forms from small batteries for various kinds of electronic devices and the like to large batteries for electric automobile and the like.

Since the non-aqueous electrolyte battery uses non-aqueous electrolyte containing a combustible material such as ethylene carbonate, the non-aqueous electrolyte battery needs measures for safety.

As the secondary battery, an aqueous electrolyte battery using, instead of a non-aqueous electrolyte, an aqueous electrolyte, which contains an aqueous solvent not having combustibility, has also been developed.

In the above-described secondary battery, a gas generated by side reaction is accumulated between a separator and an electrode, and ion conduction does not occur at this portion.

Therefore, resistance as the secondary battery increases.

### BRIEF DESCRIPTION OF THE DRAWINGS

FIG. 1 is a plan view schematically illustrating an example of an integrated sheet structure according to an embodiment.

FIG. 2 is a plan view schematically illustrating another example of the integrated sheet structure according to the embodiment.

FIG. 3 is a plan view schematically illustrating still another example of the integrated sheet structure according to the embodiment.

FIG. 4 is a plan view schematically illustrating a composite layer and a substrate layer which a third mixture layer has.

FIG. 5 is a cross-sectional view schematically illustrating an example of a secondary battery according to an embodiment.

FIG. 6 is a cross-sectional view of the secondary battery illustrated in FIG. 5 taken along line IV-IV.

FIG. 7 is a partially cut-out perspective view schematically illustrating another example of the secondary battery according to the embodiment.

FIG. 8 is an enlarged cross-sectional view of section B of the secondary battery illustrated in FIG. 7.

FIG. 9 is a perspective view schematically illustrating an example of an assembled battery according to an embodiment.

FIG. 10 is a perspective view schematically illustrating an example of a battery pack according to an embodiment.

FIG. 11 is an exploded perspective view schematically illustrating another example of the battery pack according to the embodiment.

FIG. 12 is a block diagram illustrating an example of an electric circuit of the battery pack illustrated in FIG. 11.

FIG. 13 is a partial transparent view schematically illustrating an example of a vehicle according to an embodiment.

FIG. 14 is a block diagram illustrating an example of a system including a stationary power supply according to an embodiment.

### DETAILED DESCRIPTION

Hereinafter, embodiments will be described with reference to the drawings. In the following description, constituents exhibiting the same or similar function are denoted by the same reference signs throughout all drawings, and the overlapping description will be omitted. Each drawing is a schematic view to facilitate the description and understanding of the embodiments, and the shape, size, ratio, and the like thereof are different from those of an actual device, but these can be appropriately designed and modified by taking into consideration the following description and known techniques.

Unless otherwise specified, various measurements are performed at 25° C.

### First Embodiment

According to a first embodiment, there is provided an integrated sheet structure for a secondary battery, including: a first mixture layer containing a first active material and a first binder; a second mixture layer containing a second active material and a second binder; and a third mixture layer located between the first mixture layer and the second mixture layer and containing solid particles and a third binder, in which the first mixture layer and the third mixture layer are bonded each other, and the second mixture layer and the third mixture layer are bonded each other.

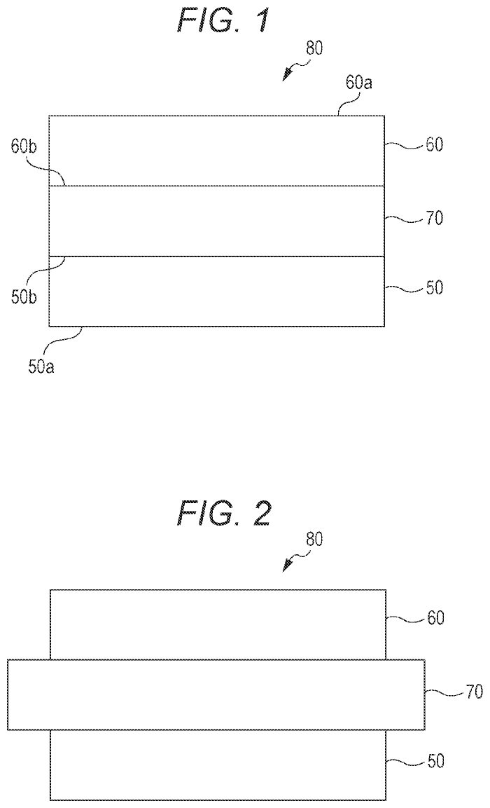

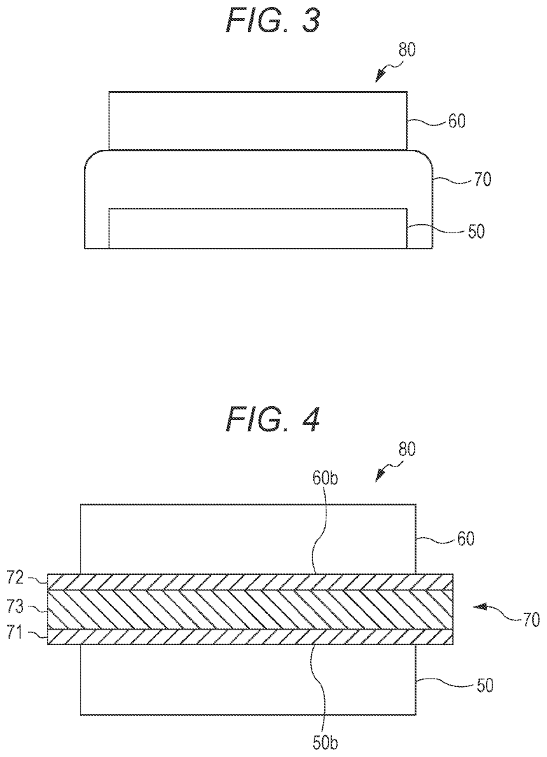

FIG. 1 is a plan view schematically illustrating an example of an integrated sheet structure according to the first embodiment. FIGS. 2 and 3 are plan views schematically illustrating another example of an integrated sheet structure according to the first embodiment.

In FIG. 1, a third mixture layer 70 functioning as a separator is located between a first mixture layer 50 and a second mixture layer 60 functioning as active material-containing layers. In FIG. 1, in a plane direction intersecting with a thickness direction of the third mixture layer 70, the third mixture layer 70 has the same side length as those of the first mixture layer 50 and the second mixture layer 60, and the third mixture layer 70 has the same area as those of the first mixture layer 50 and the second mixture layer 60.

The first mixture layer 50 has a first-a main surface 50a bonding to a first current collector in a secondary battery described in a second embodiment. The first mixture layer 50 has a first-b main surface 50b located on a side opposite to the first-a main surface 50a and bonding to the third mixture layer 70.

The second mixture layer 60 has a second-a main surface 60a bonding to a second current collector, similarly to the first mixture layer, in the secondary battery described in the second embodiment. The second mixture layer 60 has a second-b main surface 60b located on a side opposite to the second-a main surface 60a and bonding to the third mixture layer 70.

In FIG. 1, the first mixture layer 50 and the third mixture layer 70 are bonded each other, and the second mixture layer 60 and the third mixture layer 70 are bonded each other. When the bonding between the respective mixture layers described above is high, gaps at the interface therebetween can be physically reduced. Thereby, formation of liquid accumulation of the electrolyte can be suppressed between the first mixture layer 50 and the third mixture layer 70 and between the second mixture layer 60 and the third mixture layer 70. Thus, a region containing a large amount of water derived from the aqueous electrolyte at the interface therebetween can be reduced. Therefore, in a secondary battery including such an integrated sheet structure 80, contact between water in the electrolyte and a material contained in the electrode is reduced, and according to this, the electrolysis of water is suppressed. Since a change in a distance between electrodes due to gas generation caused by the electrolysis of water can be suppressed, an increase in resistance as the secondary battery can be suppressed.

In FIG. 2, in a plane direction intersecting with a thickness direction of the third mixture layer, the third mixture layer extends longer than the first mixture layer 50 and the second mixture layer 60, and the third mixture layer has a larger area than the first mixture layer and the second mixture layer. Therefore, when a battery is produced by cutting or punching of the integrated sheet structure 80, contact between the current collector and the first mixture layer 50 and the second mixture layer 60, both of which function as electrodes, can be suppressed, and as a result, internal short circuit can be suppressed.

In FIG. 3, in the first mixture layer 50, a surface parallel to the thickness direction, that is, at least a part of the side surface of the first mixture layer 50 is covered with the third mixture layer 70. Thereby, entering of water from the side surface of the first mixture layer 50 can be prevented. All the side surfaces of the first mixture layer may be covered. Entering of water from the side surface can be further prevented when all the side surfaces are covered. In FIG. 3, although at least a part of the side surface of the first mixture layer 50 is covered with the third mixture layer 70, at least a part of the side surface of the second mixture layer 60 instead of the first mixture layer 50 may be covered with the third mixture layer 70.

In the integrated sheet structure according to the present embodiment, a peeling strength measured in a 180-degree peeling test is 50 N/20 mm or more and 250 N/20 mm or less. The peeling strength of 50 N/20 mm or more measured in a 180-degree peeling test indicates that the first mixture layer and the third mixture layer are strongly bonded each other and the second mixture layer and the third mixture layer are strongly bonded each other. As a result, the electrolysis of water by side reaction described above can be suppressed. The peeling strength is preferably 150 N/20 mm or more and 200 N/20 mm or less. In the 180-degree peeling test, measurement can be performed, for example, as follows.

<Measurement Method of Peeling Strength of Integrated Sheet Structure>

First, when the integrated sheet structure is included inside the secondary battery, after the secondary battery is discharged, the secondary battery is disassembled and the electrode is extracted. In the case of an aqueous lithium ion battery, the battery may be disassembled in the air, but in the case of a lithium ion battery using a non-aqueous solvent, the battery is disassembled in a glove box under an inert gas atmosphere such as argon gas. The discharge state refers to a state where the battery is charged until the charging rate is 0%. In the case of the aqueous lithium ion battery, the extracted electrode is immersed in pure water for 3 minutes and then dried at 100° C. for 5 minutes. In the case of the lithium ion battery using a non-aqueous solvent, the extracted electrode is immersed in a solvent for 3 minutes and then dried in a glove box under an inert gas atmosphere. As the solvent, for example, diethyl carbonate is used.

After the above treatment, the current collector is removed from the electrode. The integrated sheet structure of the first mixture layer, the second mixture layer, and the third mixture layer is cut into a width of 2 cm×a length of 5 cm. Next, one side of a double-sided tape having a width of 2 cm×a length of 2.5 cm is pasted to cover a half of one side surface of the integrated sheet structure and the other surface of the double-sided tape is pasted onto a base.

At this time, the double-sided tape is not pasted to a portion having a width of 2 cm×a length of 2.5 cm that is the other half of the one side surface of the integrated sheet structure. Thereafter, the portion of the integrated sheet structure to which the double-sided tape is not pasted is bent so as to be parallel to the base. The base is set on a peeling strength tester, and the portion of the integrated sheet structure to which the double-sided tape is not pasted is attached to a sample fixation portion of the peeling strength tester. As a measurement condition, a peeling strength (N/20 mm) of the integrated sheet structure is measured at a speed (pulling speed) of 20 mm/min. Thereby, the peeling strength of the integrated sheet structure can be measured.

When the current collector is strongly bonded to the integrated sheet structure and the current collector is difficult to remove, the above measurement is performed directly for the electrode in which the current collector is bonded to the integrated sheet structure. For example, in the measurement, when the peeling strength is 60 N/20 mm, the peeling strength of the integrated sheet structure is regarded to be 60 N/20 mm. This is because the peeling strength between the current collector and the integrated sheet structure is smaller than the peeling strength between the third mixture layer and the first and second mixture layers in the integrated sheet structure.

Hereinafter, details of the integrated sheet structure according to the embodiment will be described.

(First Mixture Layer)

The first mixture layer contains an active material-containing layer. The active material-containing layer contains a first active material, a conductive agent, and a first binder. The first mixture layer includes a first-b main surface and a first-a main surface corresponding to a main surface on a back side of the first-b main surface. The first-b main surface is bonded to the third mixture layer. The first-a main surface is bonded to a first current collector included in the secondary battery according to the second embodiment. The first mixture layer functions as a negative electrode or a positive electrode when bonding to the first current collector in the secondary battery according to the second embodiment. A case where the first mixture layer has a negative electrode active material-containing layer will be described here. The first mixture layer is also called a first electrode mixture layer.

A median diameter of pores in the first mixture layer is preferably 0.05 μm or more and less than 0.5 μm. The median diameter of pores depends on the particle size of the active material, and the median diameter of pores decreases as the particle size of the active material decreases. When the median diameter of pores in the first mixture layer is less than 0.05 μm, the particle size of the active material decreases so as to increase an area of the active material in contact with an electrolytic solution, so that insertion and desorption of Li ions are likely to occur, but the electrolysis of water occurring as side reaction also actively occurs. On the other hand, when the median diameter of pores in the first mixture layer exceeds 0.5 μm, the particle size of the active material sufficiently increases, so that insertion and desorption of Li ions are less likely to occur. As a result, resistance increases so that a charge-discharge reaction is less likely to occur. The median diameter of pores in the first mixture layer described above can be measured as follows.

<Measurement of Gaps of First and Second Mixture Layers By Mercury Porosimetry>

An electrode as a measurement sample is cut to obtain a plurality of test pieces. The size of the test piece has, for example, a strip shape having a short side of 1.25 cm and a long side of 2.5 cm.

Next, a plurality of test pieces are placed in a measurement cell of a measuring apparatus and mercury is caused to enter into pores of the test pieces. The number of test pieces is set, for example, to 16 or more and 32 or less. As the measurement cell, for example, a 5-cc cell for large pieces having a stem volume of 0.4 cc is used. As the measuring apparatus, for example, SHIMADZU AutoPore 9520 (Autopore 9520 model manufactured by SHIMADZU CORPORATION) is used. In the measurement, for example, an initial pressure is set to 7 kPa, and an end pressure is set to 414 MPa. The measurement is performed every pressure of 1.1n times the initial pressure. n is a positive integer. That is, the measurement is performed until the pressure reaches 414 MPa, for example, with 7 kPa, 7.7 kPa, 8.47 kPa, 9.317 kPa, . . . 7×1.1ⁿ⁻¹ times kP as measurement points. 7 kPa corresponds to 1.0 psia (pound per square inch absolute) and corresponds to a pore of a diameter of about 180 μm. 414 MPa corresponds to about 6 psia and corresponds to a pore of a diameter of about 0.003 μm. A mercury contact angle is set to 130 degrees, and a mercury surface tension is set to 485 dynes/cm. A log differential pore volume distribution curve and total pore volume of the active material-containing layer, and a pore volume by each range of each pore size can be obtained by processing the obtained data.

The first mixture layer contains a first active material, a conductive agent, and a first binder. The first mixture layer desirably contains, as the active material, the first active material containing a compound whose lithium ion insertion-desorption potential is 1 V or more and 3 V or less (vs. Li/Li⁺) with respect to the oxidation-reduction potential of lithium.

In an aqueous electrolyte battery including, as a negative electrode, an electrode containing a compound whose lithium ion insertion-desorption potential is within the above range in an active material, at the time of the initial charge, water contained in the solvent of the aqueous electrolyte may be electrolyzed inside the negative electrode and in the vicinity of the negative electrode. This is because the potential of the negative electrode is decreased by insertion of lithium ions into the negative electrode active material at the time of the initial charge. When the negative electrode potential decreases more than the hydrogen generation potential, some of water is decomposed into hydrogen (H₂) and hydroxide ions (OH−) inside the negative electrode and in the vicinity of the negative electrode. As a result, the pH of the aqueous electrolyte existing inside the negative electrode and in the vicinity of the negative electrode increases.

The hydrogen generation potential in the negative electrode depends on the pH of the aqueous electrolyte. That is, when the pH of the aqueous electrolyte in contact with the negative electrode increases, the hydrogen generation potential in the negative electrode decreases. In a battery using a negative electrode active material whose lower limit value of the lithium ion insertion-desorption potential is 1 V or more (vs. Li/Li⁺), the potential of the negative electrode at the time of the initial charge is lower than the hydrogen generation potential, but after the initial charge, the potential of the negative electrode is likely to be higher than the hydrogen generation potential, so that decomposition of water in the negative electrode becomes hard to occur.

As described above, in the integrated sheet structure, when the integrated sheet structure is assembled in a secondary battery, liquid accumulation of water is less likely formed at an interface where both electrode surfaces of the separator are located. This is also because water hardly penetrates into the above-described interface from the outside of the integrated sheet structure. Thus, in the secondary battery using the integrated sheet structure, the pH of the aqueous electrolyte existing in the negative electrode and in the vicinity of the negative electrode can be maintained in a high level after the initial charge. Therefore, when the compound whose lower limit value of the lithium ion insertion-desorption potential is 1 V or more (vs. Li/Li⁺) is used as the first active material (negative electrode active material) to be contained in the active material-containing layer of the integrated sheet structure, the electrolysis of water can be suppressed. As a result, since a change in a distance between electrodes caused by the generated gas can be suppressed, an increase in resistance as the secondary battery can be suppressed.

Examples of the compound whose lithium ion insertion-desorption potential is 1 V or more and 3 V or less (vs. Li/Li⁺) in terms of potential based on the oxidation-reduction potential of lithium include a titanium oxide and a titanium-containing oxide. Examples of the titanium-containing oxide include a lithium titanium composite oxide, a niobium titanium composite oxide, and a sodium niobium titanium composite oxide. The first active material can contain one or more types of the titanium oxide and the titanium-containing oxide.

The titanium oxide includes, for example, a titanium oxide having a monoclinic structure, a titanium oxide having a rutile structure, and a titanium oxide having an anatase structure. For the titanium oxides of these crystal structures, the composition before charge can be expressed as TiO₂, and the composition after charge can be expressed as Li_{y}TiO₂ (subscript y is 0≤y≤1). The structure of the titanium oxide having a monoclinic structure before charge can be expressed as TiO₂ (B).

Examples of the lithium titanium composite oxide include a lithium titanium oxide having a spinel structure (for example, a compound represented by general formula Li₄₊ⱼTi₅O₁₂ where −1≤j≤3), a lithium titanium oxide having a ramsdellite structure (for example, a compound represented by Li₂₊ⱼTi₃O₇ where −1≤j≤3), a compound represented by Li_{1+y}Ti₂O₄ where 0≤y≤1, a compound represented by Li_{1.1+y}Ti_{1.8}O₄ where 0≤y≤1, a compound represented by Li_{1.07+y}Ti_{1.86}O₄ where 0≤y≤1, and a compound represented by LiₖTiO₂ where 0<k≤1. The lithium titanium oxide may be a lithium titanium composite oxide in which a doping element is introduced.

The niobium titanium composite oxide includes, for example, a compound represented by Li_{χ}TiMe_{α}Nb_{2±β}O_{7±σ}, where 0≤χ≤5, 0≤α≤0.3, 0≤β≤0.3, 0≤σ≤0.3, and Me is one or more selected from the group consisting of Fe, V, Mo, and Ta.

The sodium niobium titanium composite oxide includes, for example, an orthorhombic Na-containing niobium titanium composite oxide represented by general formula: Li_{2+d}Na₂₋ₑMe1_{f}Ti_{6-g-h}Nb_{g}Me2ₕO_{14+δ}, where 0≤d≤4, 0e≤2, 0≤f<2, 0<g<6, 0≤h<3, g+h<6, −0.5≤δ≤0.5, Me1 includes one or more selected from Cs, K, Sr, Ba, and Ca, and Me2 includes one or more selected from Zr, Sn, V, Ta, Mo, W, Fe, Co, Mn, and Al.

As the first active material (negative electrode active material), a titanium oxide having an anatase structure, a titanium oxide having a monoclinic structure, a lithium titanium oxide having a spinel structure, a niobium titanium composite oxide, or a mixture thereof can be used. Meanwhile, when a titanium oxide having an anatase structure, a titanium oxide having a monoclinic structure, or a lithium titanium oxide having a spinel structure is used as the negative electrode active material, for example, a high electromotive force can be obtained by combination with the second mixture layer using a lithium manganese composite oxide as a counter electrode for the electrode included in an electrode structure in the second active material (positive electrode active material). On the other hand, by using a niobium titanium composite oxide, a high capacity can be exhibited.

The first active material may be contained in the active material-containing layer in a form of, for example, particles. The first active material particles may be primary particles, secondary particles as the aggregates of primary particles, or a mixture of single primary particles and secondary particles. The shape of the particle is not particularly limited, and may be, for example, spherical, elliptical, flat, fibrous, or the like.

The secondary particles of the first active material can be obtained, for example, by the following method. First, active material raw materials are reactively synthesized to produce an active material precursor having an average particle size of 1 μm or less. Thereafter, a calcination treatment is performed for the active material precursor, and a grinding treatment is performed using a grinder such as a ball mill or a jet mill. Next, in the calcination treatment, the active material precursor is agglomerated to grow secondary particles with a larger particle size.

The average particle size (diameter) of the secondary particles of the first active material is preferably 3 μm or more and more preferably 5 μm or more and 20 μm or less. Within this range, since the surface area of the active material is small, decomposition of water can further be suppressed.

The average particle size of the primary particles of the first active material is desirably 1 μm or less. This shortens the diffusion distance of Li ions in the active material and increases the specific surface area. Therefore, excellent high input performance (rapid charge) can be obtained. On the other hand, when the average particle size of the primary particles of the first active material is small, agglomeration of the particles is likely to occur. When agglomeration of the particles of the first active material occurs, the aqueous electrolyte is easily unevenly distributed on the electrode side in the secondary battery, and the ionic species may be exhausted in the counter electrode. Therefore, the average particle size of the primary particles of the first active material is preferably 0.001 μm or more. The average particle size of the primary particles of the first active material is more preferably 0.1 μm or more and 0.8 μm or less. Note that, each of the primary particle size and the secondary particle size means a particle size with which a volume integrated value becomes 50% in a particle size distribution obtained by a laser diffraction type particle size distribution measuring apparatus. As the laser diffraction type particle size distribution measuring apparatus, for example, SHIMADZU SALD-300 is used. For measurement, luminous intensity distribution is measured 64 times at intervals of 2 seconds. As a sample used when the particle size distribution is measured, a dispersion obtained by diluting active material particles with N-methyl-2-pyrrolidone such that the concentration of the active material particles becomes 0.1 mass % to 1 mass % is used. Alternatively, a measurement sample obtained by dispersing 0.1 g of an active material in 1 ml to 2 ml of distilled water containing a surfactant is used.

The conductive agent is blended if necessary to enhance current collection performance and suppress the contact resistance between the active material (first active material) and a current collector layer. Examples of the conductive agent include carbonaceous materials such as acetylene black, Ketjen black, graphite, and coke. The conductive agent may be of one type, or two or more types thereof may be used as a mixture.

The first binder has an action of binding the active material (first active material) and the conductive agent. As the first binder, at least one selected from the group consisting of, for example, polytetrafluoroethylene (PTFE), polyvinylidene fluoride (PVdF), cellulose-based polymer such as carboxymethylcellulose (CMC), fluorine-based rubber, styrene-butadiene rubber, an acrylic resin or a copolymer thereof, polyacrylic acid, and polyacrylonitrile can be used, but the first binder is not limited thereto. The first binder may be of one type, or two or more types thereof may be used as a mixture. A binder that is the same as or different from the second binder described below may be used.

The blending ratios of the first active material, the conductive agent, and the first binder in the first mixture layer are preferably in ranges of 70 mass % or more and 95 mass % or less, 3 mass % or more and 20 mass % or less, and 2 mass % or more and 10 mass % or less, respectively. When the blending ratio of the conductive agent is 3 mass % or more, the conductivity of the first mixture layer can be improved, and when the blending ratio thereof is 20 mass % or less, decomposition of the aqueous electrolyte on the conductive agent surface can be reduced. When the blending ratio of the first binder is 2 mass % or more, a sufficient electrode strength can be obtained, and when the blending ratio thereof is 10 mass % or less, the insulating portion of the electrode can be decreased.

(Second Mixture Layer)

The second mixture layer contains an active material-containing layer. The second mixture layer includes a second-b main surface and a second-a main surface corresponding to a main surface on a back side of the second-b main surface. The second-b main surface is bonded to the third mixture layer. The second-a main surface is bonded to a second current collector included in the secondary battery according to the second embodiment. The second mixture layer functions as a positive electrode or a negative electrode when bonding to the second current collector in the secondary battery according to the second embodiment. A case where the second mixture layer has a positive electrode active material-containing layer will be described here. The second mixture layer is also called a second electrode mixture layer.

A median diameter of pores in the second mixture layer is preferably 0.1 μm or more and less than 0.5 μm. The measurement method of the median diameter of pores in the second mixture layer described above has been described in the section of the first mixture layer, and thus the description thereof will be omitted.

The second mixture layer contains a second active material, a conductive agent, and a second binder. As the positive electrode active material (second active material), a compound whose lithium ion insertion-desorption potential is 2.5 V or more and 5.5 V or less (vs. Li/Li⁺) with respect to the oxidation-reduction potential of lithium can be used. The second mixture layer may contain one type of compound alone as the second active material or may contain two or more types of compounds as the positive electrode active material.

Examples of the compound that can be used as the positive electrode active material include a lithium manganese composite oxide, a lithium nickel composite oxide, a lithium cobalt aluminum composite oxide, a lithium nickel cobalt manganese composite oxide, a spinel type lithium manganese nickel composite oxide, a lithium manganese cobalt composite oxide, a lithium iron oxide, a lithium fluorinated iron sulfate, and a phosphate compound having an olivine crystal structure (for example, a compound represented by LiₖFePO₄ where 0<k≤1 or a compound represented by LiₖMnPO₄ where 0<k≤1). The phosphate compound having an olivine crystal structure has excellent thermal stability.

Examples of the compound capable of obtaining a high positive electrode potential include lithium manganese composite oxides such as a compound having a spinel structure and represented by LiₖMn₂O₄ where 0<k≤1 and a compound represented by LiₖMnO₂ where 0<k≤1; lithium nickel aluminum composite oxides such as a compound represented by LiₖN₁₋ᵢAlᵢO₂ where 0<k≤1, 0<i<1; lithium cobalt composite oxides such as a compound represented by LiₖCoO₂ where 0<k≤1; lithium nickel cobalt composite oxides such as a compound represented by LiₖNi₁₋ᵢ₋ₜCoᵢMnₜO₂ where 0<k≤1, 0<i<1, and 0≤t<1; lithium manganese cobalt composite oxides such as a compound represented by LiₖMnᵢCo₁₋ᵢO₂ where 0<k≤1 and 0<i<1; spinel type lithium manganese nickel composite oxides such as a compound represented by LiₖMn₂₋ₓNiₓO₄ where 0<k≤1 and 0<K<2; lithium phosphorus oxides having an olivine structure such as a compound represented by LiₖFePO₄ where 0<k≤1, a compound represented by LiₖFe_{1-y}Mn_{y}PO₄ where 0<k≤1 and 0≤y≤1, and a compound represented by LiₖCoPO₄ where 0<k≤1; and a fluorinated iron sulfate (for example, a compound represented by LiₖFeSO₄F where 0<k≤1).

As the positive electrode active material, one or more selected from the group consisting of a lithium cobalt composite oxide, a lithium manganese composite oxide, and a lithium phosphorus oxide having an olivine structure are preferably contained. The operating potentials of these compounds are 3.5 V (vs. Li/Li⁺) or more and 4.2 V (vs. Li/Li⁺) or less. That is, the operating potentials of these compounds as the active materials are relatively high. By using these compounds in combination with the above-described negative electrode active materials such as a spinel type lithium titanate and an anatase type titanium oxide, a high battery voltage can be obtained.

The positive electrode active material is contained in the positive electrode in a form of, for example, particles. The positive electrode active material particles may be single primary particles, secondary particles as the aggregates of primary particles, or a mixture of primary particles and secondary particles. The shape of the particle is not particularly limited, and can be, for example, spherical, elliptical, flat, fibrous, or the like.

The average particle size (diameter) of the primary particles of the positive electrode active material is preferably 10 μm or less and more preferably 0.1 μm or more and 5 μm or less. The average particle size (diameter) of the secondary particles of the positive electrode active material is preferably 100 μm or less and more preferably 10 μm or more and 50 μm or less. The primary particle size and the secondary particle size of the positive electrode active material can be measured by the same method as that of the negative electrode active material particles.

The positive electrode active material-containing layer may contain a conductive agent, a second binder, and the like, in addition to the positive electrode active material.

The same conductive agent as that described in the first mixture layer can be used. The conductive material used in the second mixture layer may be the same as or different from the conductive material used in the first mixture layer.

As the second binder, a binder that is the same as or different from the first binder may be used. The blending ratios of the second active material, the conductive agent, and the second binder in the second mixture layer may be the same as the blending ratios of the first active material, the conductive agent, and the first binder in the first mixture layer described above.

(Third Mixture Layer)

The third mixture layer is located between the first mixture layer and the second mixture layer functioning as electrodes when assembled in a secondary battery, and contains solid particles and a third binder. The third mixture layer has a function as a separator electrically insulating the first mixture layer and the second mixture layer.

The third mixture layer is a composite layer containing inorganic solid particles and a third binder, and in a secondary battery using this composite layer as a separator, a liquid electrolyte or an electrolyte solvent can penetrate into small gaps between the inorganic solid particles and the third binder to form a lithium ion (Li⁺) conduction path. When the aqueous electrolyte is used, water in the electrolyte is constrained to some extent, but can move in the composite film or bleed out of the composite film. Therefore, by enhancing the boning at interfaces between the third mixture layer and the first and second mixture layers, generation of liquid accumulation of water derived from the aqueous electrolyte at the interfaces therebetween can be suppressed. In this liquid accumulation, since a large amount of water molecules serving as reactants in the electrolysis reaction of water are concentrated, proceeding of the electrolysis reaction to the product side containing hydrogen can be suppressed by suppression of the liquid accumulation. For example, hydrogen generation may occur due to water accumulated at an interface between the composite film and the negative electrode.

The third mixture layer desirably has high denseness and high water-blocking properties. In the integrated sheet structure including the third mixture layer having high denseness and high water-blocking properties, an air permeability coefficient of a joined structure of the third mixture layer, the first mixture layer, and the second mixture layer may be 5×10⁻¹⁵ m² or less. The air permeability coefficient is preferably 1×10⁻¹⁵ m² or less. The lower limit value of the air permeability coefficient of the joined structure is not particularly limited, and is, for example, 1×10⁻¹⁹ m² or more. The air permeability coefficient may be specifically, for example, within a range of 6.5×10⁻¹⁹ m² or more and 5×10⁻¹⁵ m² or less.

The third mixture layer can include a substrate layer in addition to the composite layer. FIG. 4 is a plan view schematically illustrating a composite layer and a substrate layer which a third mixture layer has. The third mixture layer 70 includes a composite layer 71 bonding to the first-b main surface 50b of the first mixture layer 50 and a composite layer 72 bonding to the second-b main surface 60b of the second mixture layer 60.

In FIG. 4, a substrate layer 73 may be provided on a surface of the composite layer 71 bonding to the first-b main surface 50b of the first mixture layer 50 on a back side with respect to the surface bonding to the first-b main surface 50b. The substrate layer 73 may be further provided with the composite layer 72 bonding to the second-b main surface 60b of the second mixture layer 60 in a surface on a back side with respect to the surface bonding to the composite layer 71.

The substrate layer 73 is made of, for example, a porous material described below, and includes a large number of holes as compared with the composite layers 71 and 72. Therefore, the substrate layer 73 can held a larger amount of the electrolyte than the composite layers 71 and 72. That is, the integrated sheet structure including the third mixture layer 70, the first mixture layer 50, and the second mixture layer 60 is configured in which the substrate layer 73 bonding to the composite layers 71 and 72 is included in the third mixture layer 70 and the first mixture layer 50, the composite layer 71, the substrate layer 73, the composite layer 72, and the second mixture layer 60 are arranged in this order. Thereby, the amount of the electrolyte held can be increased at a portion of the substrate layer 73, which is separated from the first mixture layer 50 and the second mixture layer 60 functioning as electrodes in the case of including a current collector, of the third mixture layer 70, and the amount of the electrolyte held can be decreased at a portion of the third mixture layer 70 bonding to the electrode. By including the substrate layer 73 in the third mixture layer 70, impregnation performance of the electrolyte can be made favorable while high denseness is maintained in the third mixture layer 70.

The third mixture layer 70 may include only the composite layer and may not include the substrate layer 73. In FIG. 4, the third mixture layer 70 includes the substrate layer 73, the composite layer 71 bonding to the first-b main surface 50b, and the composite layer 72 bonding to the second-b main surface 60b, but the composite layer may be only one. That is, for example, the substrate layer 73 may be provided with the composite layer 71 bonding to the first-b main surface 50b, and the second mixture layer 60 may be provided such that the surface on a back side of the substrate layer 73 bonding to the composite layer 71 is bonded to the second-b main surface 60b. Alternatively, the substrate layer 73 may be provided with the first mixture layer 50 such that the substrate layer is bonded to the first-b main surface 50b, and the composite layer 72 may be provided on the surface on a back side of the substrate layer 73 bonding to the first mixture layer 50.

Examples of solid particles contained in the composite layer include inorganic solid particles. Examples of the inorganic solid particles include oxide-based ceramics such as alumina, silica, zirconia, yttria, magnesium oxide, calcium oxide, barium oxide, strontium oxide, and vanadium oxide; carbonates and sulfates such as sodium carbonate, potassium carbonate, magnesium carbonate, calcium carbonate, barium carbonate, lanthanum carbonate, cerium carbonate, calcium sulfate, magnesium sulfate, aluminum sulfate, gypsum, and barium sulfate; phosphates such as hydroxyapatite, lithium phosphate, zirconium phosphate, and titanium phosphate; and nitride-based ceramics such as silicon nitride, titanium nitride, and boron nitride. The inorganic particles exemplified above may be in a form of a hydrate.

The inorganic solid particles preferably include solid electrolyte particles having ionic conductivity of alkali metal ions. Specifically, inorganic solid particles having ionic conductivity with respect to lithium ions and sodium ions are more preferable.

Examples of inorganic solid particles having lithium ion conductivity may include an oxide-based solid electrolyte or a sulfide-based solid electrolyte. As the oxide-based solid electrolyte, a lithium phosphate solid electrolyte having a NASICON (Sodium (Na) Super Ionic Conductor) structure and represented by general formula Li₁₊ₓM₂(PO₄)₃ is preferably used. M in the above general formula is, for example, one or more selected from the group consisting of titanium (Ti), germanium (Ge), strontium (Sr), zirconium (Zr), tin (Sn), aluminum (Al), and calcium (Ca). The subscript x is within a range of 0≤x≤2. An ionic conductance of a lithium phosphate solid electrolyte represented by general formula LiM₂(PO₄)₃ is, for example, 1×10⁻⁵ S/cm or more and 1×10⁻³ S/cm or less.

Specific examples of the lithium phosphate solid electrolyte having a NASICON structure may include an LATP compound represented by Li_{1+w}Al_{w}Ti_{2-w}(PO₄)₃ where 0.1≤w≤0.5; a compound represented by Li_{1+y}Al_{z}M1_{2-z}(PO₄)₃ where M1 is one or more selected from the group consisting of Ti, Ge, Sr, Zr, Sn, and Ca, 0≤y≤1, and 0≤z≤1; a compound represented by Li₁₊ₓAlₓGe₂₋ₓ(PO₄)₃ where 0≤x≤2; a compound represented by Li₁₊ₓAlₓZr₂₋ₓ(PO₄)₃ where 0≤x≤2; a compound represented by Li₁₊ᵤ₊ᵥAlᵤMα₂₋ᵤSiᵥP₃₋ᵥO₁₂ where Mα is one or more selected from the group consisting of Ti and Ge, 0<u≤2, and 0≤v<3; and a compound represented by Li₁₊₂ₜZr₁₋ₜCaₜ(PO₄)₃ where 0≤t<1. Li₁₊₂ₜZr₁₋ₜCaₜ (PO₄)₃ is preferably used as inorganic solid electrolyte particles since it has high water resistance, reducing properties, and low cost.

In addition to the lithium phosphate solid electrolyte, examples of the oxide-based solid electrolyte include an LIPON compound in an amorphous state represented by LiₚPO_{g}Nᵣ where 2.6≤p≤3.5, 1.9≤q≤3.8, and 0.1≤r≤1.3 (for example, Li_{2.9}PO_{3.3}N_{0.46}); a compound having a garnet structure represented by La₅₊ₛAₛLa₃₋ₛMβ₂O₁₂ where A is one or more selected from the group consisting of Ca, Sr, and Ba, Mβ is one or more selected from the group consisting of Nb and Ta, and 0≤s≤0.5; a compound represented by Li₃Mγ₂₋ₛL₂O₁₂ where Mγ is one or more selected from the group consisting of Ta and Nb, L may include Zr, and 0≤s≤0.5; a compound represented by Li₇₋₃AlₛLa₃Zr₃O₁₂ where 0≤s≤0.5; and an LLZ compound represented by Li₅₊ₓLa₃M2₂₋ₓZrₓO₁₂ where M2 is one or more selected from the group consisting of Nb and Ta, and 0≤x≤2 (for example, Li₇La₃Zr₂O₁₂). The solid electrolyte may be of one type, or two or more types thereof may be used as a mixture. An ionic conductance of LIPON is, for example, 1×10⁻⁶ S/cm or more and 5×10⁻⁶ S/cm or less. An ionic conductance of LLZ is, for example, 1×10⁻⁴ S/cm or more and 5×10⁻⁴ S/cm or less.

As inorganic solid particles having ionic conductivity of sodium ions, a sodium-containing solid electrolyte may be used. The sodium-containing solid electrolyte is excellent in ionic conductivity of sodium ions. Examples of the sodium-containing solid electrolyte may include β-alumina, a sodium phosphorus sulfide, and a sodium phosphorus oxide. The sodium ion-containing solid electrolyte preferably has a glass-ceramic form.

In the case of lithium ions, the inorganic solid particles are preferably a solid electrolyte having a lithium ion conductance of 1×10⁻⁶ S/cm or more at 25° C. The lithium ion conductance can be measured, for example, by an alternating-current impedance method.

The shape of the inorganic solid particle is not particularly limited, and can be, for example, spherical, elliptical, flat, fibrous, or the like.

The average particle size of the inorganic solid particles is preferably 15 μm or less and more preferably 12 μm or less. When the average particle size of the inorganic solid particles is small, denseness of the composite layer can be enhanced.

The average particle size of the inorganic solid particles is preferably 0.01 μm or more and more preferably 0.1 μm or more. When the average particle size of the inorganic solid particles is large, aggregation of the particles tends to be suppressed.

Note that, the average particle size of the inorganic solid particles means a particle size with which a volume integrated value becomes 50% in a particle size distribution obtained by a laser diffraction type particle size distribution measuring apparatus. As a sample used when the particle size distribution is measured, a dispersion obtained by diluting inorganic solid particles with ethanol such that the concentration of the inorganic solid particles becomes 0.01 mass % to 5 mass % is used.

When the composite layers are each provided on both front and back main surfaces of the substrate layer, the inorganic solid particles contained in each composite layer may be the same as or different from each other. As the inorganic solid particles in the composite layer, one kind of inorganic solid particles may be used or plural kinds thereof may be mixed and used.

As the third binder, a binder that is the same as or different from the first binder or the second binder may be used. The blending ratio of the third binder in the third mixture layer is in a range of 1 mass % or more and 30 mass % or less. When the blending ratio is less than 1 mass %, it is not possible to obtain a sufficient strength of the third mixture layer. On the other hand, when the blending ratio exceeds 30 mass %, penetration of the electrolytic solution in the third mixture layer becomes poor, and operation as a battery is not performed.

A content ratio of the third binder in the third mixture layer is larger than a content ratio of the second binder in the second mixture layer and a content ratio of the first binder in the first mixture layer. Thereby, the bonding between the third mixture layer and the first mixture layer and between the third mixture layer and the second mixture layer can be enhanced, and bonding as the integrated sheet structure can be maintained. A method for determining a content ratio of each binder in each mixture layer can be performed, for example, by the following method. Here, the first binder, the second binder, and the third binder indicate the case of a binder containing fluorine. The content ratio of each binder in each mixture layer is taken as the concentration of the element derived from each binder, and in the following example, is taken as the concentration of fluorine in each mixture layer.

<Measurement Method of Content Ratio of Each Binder in Each Mixture Layer>

First, when the integrated sheet structure is assembled in a secondary battery, a treatment operation described in the measurement method of the peeling strength in which the electrode is extracted from the secondary battery to remove the current collector thereby obtaining an integrated sheet structure, is performed. <Cross-Section Processing of Integrated Sheet Structure>

As for a place where the integrated sheet structure is subjected to cross-section processing, the cross-section processing is performed three times at a position where the integrated sheet structure is divided into equal quarters along a direction in which a tab extends, or a position where a side corresponding to a long side of a substantially quadrangular shape is divided into equal quarters when the integrated sheet structure is viewed in plan view. A test piece in this measurement is obtained, for example, by subjecting the integrated sheet structure to the cross-section processing with ion milling.

<Cross-Section Observation of Integrated Sheet Structure>

Observation of the cross-section of the test piece may be performed by any method as long as the cross-section can be observed, and can be performed, for example, using a scanning electron microscope-energy dispersive X-ray spectrometry (SEM-EDX). As a device, for example, SU-8020 manufactured by Hitachi High-Technologies Corporation can be used. At this time, EDX analysis is performed while setting an acceleration voltage of SEM to 15 kV, and area analysis for each of the first, second, and third mixture layers is performed, so that a fluorine concentration can be measured.

As an observation region in area analysis for each of the first, second, and the third mixture layers, a region where the first, second, and third mixture layers exist when the cross-section is viewed in a lamination direction is selected. Herein, when the third mixture layer is configured by only the composite layer, the cross-section is imaged at a magnification that the entirety of each mixture layer is included in the observation region in the selected region, and a bonding interface between the mixture layers and surface are excluded.

Alternatively, when the third mixture layer includes the substrate layer and the composite layer, the measurement is performed as follows. First, similarly to a case where the third mixture layer is configured by only the composite layer, a region where the first, second, and third mixture layers exist when the cross-section is viewed in a lamination direction is selected. Next, for the first and second mixture layers, similarly, the cross-section is imaged at a magnification that the entirety of each mixture layer is included in the observation region in the selected region, and a bonding interface between the mixture layers and surface are excluded.

For the third mixture layer, in the selected region, the cross-section is imaged at such a magnification that only the composite layer is included in the observation region. When there is one composite layer, a concentration of an element derived from the binder in the one composite layer observed at the magnification and the imaging method described above is measured to obtain a content ratio of the third binder in the third mixture layer. When there are two composite layers, concentrations of an element derived from the binder in the two composite layers observed at the magnification and the imaging method described above are each measured and averaged to obtain a content ratio of the third binder in the third mixture layer.

For example, a concentration of an element derived from the binder in each mixture layer is a fluorine concentration, and the fluorine concentration in each mixture layer is taken as a content ratio of each binder in each mixture layer. When there are a plurality of composite layers, each composite layer is observed at the magnification and the imaging method described above, and the fluorine concentrations in the respective composite layers are averaged, so that the fluorine concentration in the third mixture layer in the cross-section can be calculated.

By measuring the fluorine concentration in each mixture layer for each cross-section of the integrated sheet structure under the above-described measurement condition and averaging the fluorine concentrations of respective mixture layers in respective images, the content ratio of each binder in each mixture layer measured can be calculated.

The fluorine concentration of the third mixture layer is 1 time or more and 30 times or less the fluorine concentrations of the first mixture layer and the second mixture layer. The fluorine concentration in each mixture layer described above means the content ratio of the binder. When the fluorine concentration in the third mixture layer is less than 1 time the fluorine concentrations of the first mixture layer and the second mixture layer, this means that the amount of the binder in the third mixture layer is small, and the strength is decreased. On the other hand, the value exceeds 30 times, the flow path of the electrolytic solution is reduced, and thus penetration of the electrolytic solution hardly occurs, so that a charge-discharge reaction is less likely to occur. The fluorine concentration of the third mixture layer is preferably 1 time or more and 20 times or less the fluorine concentrations of the first mixture layer and the second mixture layer.

The substrate layer is formed of, for example, a porous film or synthetic resin nonwoven fabric containing polyethylene (PE), polypropylene (PP), cellulose, or PVdF. From the viewpoint of safety, a porous film formed of polyethylene or polypropylene is preferably used. These porous films can melt at a certain temperature and block off the current.

The substrate layer can include a large number of holes, and can impregnate a large amount of the electrolyte. Typically, the substrate layer does not contain inorganic solid particles. For example, the ratio of the area of the inorganic solid particles in the cross-section of the substrate layer may be 5% or less.

A thickness of the substrate layer is, for example, 1 μm or more and preferably 3 μm or more. When the substrate layer is thick, the mechanical strength of the composite film is increased, and internal short circuit of the secondary battery becomes hard to occur. The thickness of the substrate layer is, for example, 30 μm or less and preferably 10 μm or less. When the substrate layer is thin, the internal resistance of the secondary battery tends to decrease, and the volumetric energy density of the secondary battery tends to increase. The thickness of the substrate layer can be measured, for example, with a scanning electron microscope.

The integrated sheet structure according to the embodiment can be produced, for example, as follows. First, the substrate layer as described above is prepared, and a slurry for the third mixture layer containing solid particles is applied onto one main surface of the substrate layer, for example, by a doctor blade method to obtain a coating film. This coating film is dried at a temperature of 50° C. to 150° C. The slurry for the first mixture layer described above is applied on the coating film and is dried at a temperature of 50° C. to 150° C. Thereafter, in the third mixture layer, a slurry for the second mixture layer is applied onto one main surface on a side opposite to the main surface onto which the first mixture layer has been applied, and the slurry for the second mixture layer was dried at a temperature of 50° C. to 150° C. The order of coating the first mixture layer and the second mixture layer may be reversed.

When the third mixture layer does not have the substrate layer, the integrated sheet structure can be produced, for example, as follows. First, the slurry of the first mixture layer described above is applied onto a first current collector described below in the second embodiment and is dried at a temperature of 50° C. to 150° C. Thereafter, a slurry for the third mixture layer containing solid particles is applied onto the first mixture layer and is dried at a temperature of 50° C. to 150° C. A slurry for the second mixture layer is applied on the coating film and is dried at a temperature of 50° C. to 150° C. The order of coating the first mixture layer and the second mixture layer may be reversed. In this way, the integrated sheet structure can be obtained. When a secondary battery described in the second embodiment is produced, before a current collector is provided in the integrated sheet structure, the Integrated sheet structure is impregnated with the electrolyte, so that a battery having favorable impregnation performance can be obtained, and the coulombic efficiency can be enhanced.

The integrated sheet structure according to the first embodiment described above includes a first mixture layer containing a first active material and a first binder, a second mixture layer containing a second active material and a second binder, and a third mixture layer located between the first mixture layer and the second mixture layer and containing solid particles and a third binder, in which the first mixture layer and the third mixture layer are bonded each other, and the second mixture layer and the third mixture layer are bonded each other. Thereby, gas generation can be suppressed, so that an increase in resistance can be suppressed in the secondary battery having the integrated sheet structure.

According to the embodiment, an integrated sheet structure suppressing an increase in resistance by suppressing gas generation is provided.

### Second Embodiment

According to the second embodiment, there is provided a secondary battery including: the integrated sheet structure of the first embodiment; an electrolyte; a first current collector; and a second current collector, in which the first current collector is located on a first-a main surface of the first mixture layer on a side opposite to a first-b main surface on which the first mixture layer and the third mixture layer are bonded each other, and the second current collector is located on a second-a main surface of the second mixture layer on a side opposite to a second-b main surface on which the second mixture layer and the third mixture layer are bonded each other.

Hereinafter, the configuration of the secondary battery according to the present embodiment will be described, but the description of the integrated sheet structure will be omitted because the integrated sheet structure has been described in the first embodiment.

(Current Collector)

The first current collector is provided on the first-a main surface of the first mixture layer, and the second current collector is provided on the second-a main surface of the second mixture layer. Hereinafter, the first current collector and the second current collector are collectively referred to as the current collector. The active material-containing layer may be supported on one surface or both front and back surfaces of the current collector. For the current collector, a material that is electrochemically stable at a potential at which the lithium ions are inserted into or desorbed from the active material is used.

A positive electrode current collector contains, for example, a metal such as stainless steel, aluminum (Al), or titanium (Ti). The positive electrode current collector has a form of, for example, a foil, a porous body, or a mesh. In order to prevent corrosion by the reaction between the positive electrode current collector and the aqueous electrolyte, the surface of the positive electrode current collector may be covered with a different kind of element. The positive electrode current collector is preferably made of a material with excellent corrosion resistance and oxidation resistance, for example, a Ti foil or the like. Note that, when Li₂SO₄ is used as the aqueous electrolyte, Al may be used as the positive electrode current collector because corrosion does not progress.

A negative electrode current collector is preferably made of, for example, copper, nickel, stainless steel, or aluminum, or an aluminum alloy containing one or more elements selected from the group consisting of Mg, Ti, Zn, Mn, Fe, Cu, and Si.

A thickness of the current collector is preferably 5 μm or more and 20 μm or less. A current collector having such a thickness can balance the strength of the electrode and weight reduction.

The current collector can include a portion where the active material-containing layer is not provided on the surface of the current collector. The portion can serve as a current collector tab.

The secondary battery according to the second embodiment can further include an exterior package member housing the integrated sheet structure and the current collector.

The secondary battery according to the second embodiment can further include a negative electrode terminal electrically connected to the negative electrode and a positive electrode terminal electrically connected to the positive electrode.

The secondary battery according to the second embodiment may be, for example, a lithium ion secondary battery. The secondary battery includes an aqueous electrolyte secondary battery containing an aqueous electrolyte and a non-aqueous electrolyte secondary battery containing a non-aqueous electrolyte.

(Electrolyte)

The electrolyte may be an aqueous electrolyte and a non-aqueous electrolyte. The electrolyte may be held in the integrated sheet structure. The electrolyte includes a first electrolyte held in the first mixture layer of the integrated sheet structure, a second electrolyte held in the second mixture layer, and a third electrolyte held in the third mixture layer. The first electrolyte, the second electrolyte, and the third electrolyte may have the same composition or a different composition. Hereinafter, unless specified otherwise, the first electrolyte, the second electrolyte, and the third electrolyte are simply referred to as the electrolyte.

The aqueous electrolyte contains an aqueous solvent and an electrolyte salt. The aqueous electrolyte is, for example, a liquid. A liquid aqueous electrolyte is an aqueous solution prepared by dissolving the electrolyte salt serving as a solute in the aqueous solvent. When the aqueous electrolytes are held in both of the negative electrode active material-containing layer and the positive electrode active material-containing layer, the types of these aqueous electrolytes may be the same as or different from each other.

The aqueous solution preferably has an aqueous solvent amount of 1 mol or more and further preferably an aqueous solvent amount of 3.5 mol or more, with respect to 1 mol of the salt serving as a solute.

As the aqueous solvent, a solution containing water can be used. The solution containing water may be pure water or a mixed solvent of water and an organic solvent. The aqueous solvent contains, for example, water at a ratio of 50 vol % or more.

Whether the water is contained in the electrolyte can be confirmed by GC-MS (Gas Chromatography-Mass Spectrometry) measurement. The salt concentration and water content in the electrolyte can be calculated by, for example, performing measurement by ICP (Inductively Coupled Plasma) emission spectrometry or the like. A predetermined amount of the electrolyte is weighed, and the concentration of the contained salt is calculated, so that a mol concentration (mol/L) can be calculated. When the specific gravity of the electrolyte is measured, the number of moles in each of the solute and the solvent can be calculated.

The aqueous electrolyte may be a gel electrolyte. The gel electrolyte is prepared by mixing the above-described liquid aqueous electrolyte and a polymeric compound and compounding them. Examples of the polymeric compound may include PVdF, polyacrylonitrile (PAN), and polyethylene oxide (PEO).

As the electrolyte salt, for example, a lithium salt, a sodium salt, or a mixture thereof can be used. One type or two or more types of the electrolyte salts can be used.

As the lithium salt, for example, lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium bis(trifluoromethanesulfonyl)imide (LiTFSI; LiN(SO₂CF₃)₂), lithium bis(fluorosulfonyl)imide (LiFSI; LiN(SO₂F)₂), lithium bis(oxalate)borate (LiBOB:LiB[(OCO)₂]₂), and the like can be used.

As the lithium salt, LiCl is preferably contained. When LiCl is used, the lithium ion concentration of the aqueous electrolyte can be increased. The lithium salt preferably includes at least one of LiSO₄ and LiOH in addition to LiCl.

As the sodium salt, sodium chloride (NaCl), sodium sulfate (Na₂SO₄), sodium hydroxide (NaOH), sodium nitrate (NaNO₃), sodium trifluoromethanesulfonyl amide (NaTFSA), and the like can be used.

The mol concentration of the alkali metal ions (for example, lithium ions) in the aqueous electrolyte may be 3 mol/L or more, 6 mol/L or more, or 12 mol/L or more. For example, the mol concentration of the alkali metal ions in the aqueous electrolyte is 14 mol/L or less. When the concentration of the alkali metal ions in the aqueous electrolyte is high, there is a tendency that electrolysis of the aqueous solvent in the negative electrode is easily suppressed and hydrogen generation from the negative electrode is little. The aqueous electrolyte preferably contains, as an anion species, at least one or more selected from a chloride ion (Cl−), a hydroxide ion (OH−), a sulfate ion (SO4²⁻), and a nitrate ion (NO³⁻).

A pH of the aqueous electrolyte is preferably 3 or more and 14 or less and more preferably 4 or more and 13 or less. When a different electrolyte is used in each of a negative electrode side electrolyte and a positive electrode side electrolyte, the pH of the negative electrode side electrolyte is preferably within a range of 3 or more and 14 or less, and the pH of the positive electrode side electrolyte is preferably within a range of 1 or more and 8 or less.

When the pH of the negative electrode side electrolyte is within the above range, the hydrogen generation potential in the negative electrode lowers, so that hydrogen generation in the negative electrode is suppressed. Thereby, the storage performance and cycle life characteristics of the battery are improved. When the pH of the positive electrode side electrolyte is within the above range, the oxygen generation potential in the positive electrode increases, so that oxygen generation in the positive electrode is decreases. Thereby, the storage performance and cycle life characteristics of the battery are improved. The pH of the positive electrode side electrolyte is more preferably within a range of 3 or more and 7.5 or less.

The aqueous electrolyte may contain a surfactant. Examples of the surfactant include non-ionic surfactants such as polyoxyalkylene alkyl ether, polyethylene glycol, polyvinyl alcohol, thiourea, disodium 3,3′-dithiobis(1-propanphosphate), dimercaptothiadiazole, boric acid, oxalic acid, malonic acid, saccharin, sodium naphthalene sulfonate, gelatin, potassium nitrate, aromatic aldehyde, and heterocyclic aldehyde. The surfactant may be used alone or two or more types thereof can be used as a mixture.

The pHs of the aqueous electrolyte on the negative electrode side and the positive electrode side are preferably different after the initial charge. In the secondary battery after the initial charge, the pH of a first aqueous electrolyte on the negative electrode side is preferably 3 or more, more preferably 5 or more, and further preferably 7 or more. In the secondary battery after the initial charge, the pH of a third aqueous electrolyte on the positive electrode side is preferably within a range of 0 or more and 7 or less and more preferably within a range of 0 or more and 6 or less.

The pHs of the aqueous electrolyte on the negative electrode side and the positive electrode side can be obtained by, for example, disassembling the secondary battery and measuring the pH of the aqueous electrolyte existing between the separator and the negative electrode and the pH of the aqueous electrolyte existing between the separator and the positive electrode.

As the electrolyte, instead of the aqueous electrolyte, a liquid non-aqueous electrolyte or a gel non-aqueous electrolyte can be used. The liquid non-aqueous electrolyte is prepared by dissolving the electrolyte salt serving as a solute in an organic solvent.

Examples of the electrolyte salt include lithium salts such as lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate (LiCF₃SO₃), bis-trifluoromethyl sulfonyl imide lithium (LiN(CF₃SO₂)₂), and lithium bis(fluorosulfonyl)imide (LiN(SO₂F)₂; LiFSI), and a mixture thereof.

Examples of the organic solvent include cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2MeTHF), and dioxolane (DOX); linear ethers such as dimethoxy ethane (DME) and diethoxy ethane (DEE); and γ-butyrolactone (GBL), acetonitrile (AN), and sulfolane (SL). These organic solvents can be used alone or used as a mixed solvent.

The gel non-aqueous electrolyte is prepared by compounding a liquid non-aqueous electrolyte and a polymeric material. Examples of the polymeric material include PVdF, polyacrylonitrile (PAN), polyethylene oxide (PEO), and a mixture thereof.

Alternatively, as the non-aqueous electrolyte, instead of the liquid non-aqueous electrolyte and the gel non-aqueous electrolyte, a room-temperature molten salt (ionic melt) containing lithium ions, a polymeric solid electrolyte, an inorganic solid electrolyte, or the like may be used.

The room-temperature molten salt (ionic melt) is a compound which may exist as a liquid at room temperature (15° C. or higher and 25° C. or lower) among organic salts consisting of the combination of an organic cation and anion. The room-temperature molten salt includes a room-temperature molten salt which exists as a liquid alone, a room-temperature molten salt which becomes a liquid by being mixed with an electrolyte salt, a room-temperature molten salt which becomes a liquid by being dissolved in an organic solvent, or a mixture thereof. Generally, a melting point of a room-temperature molten salt used for a secondary battery is 25° C. or lower. The organic cation generally has a quaternary ammonium frame.

(Exterior Package Member)

As the exterior package member housing an electrode group and an aqueous electrolyte, a metal container, a laminate film container, or a resin container can be used.

As the metal container, a metal can made of nickel, iron, stainless steel, or the like and having a rectangular shape or a cylindrical shape can be used. As the resin container, a container made of polyethylene, polypropylene, or the like can be used.

A board thickness of each of the resin container and the metal container preferably within a range of 0.05 mm or more and 1 mm or less. The board thickness is more preferably 0.5 mm or less and further preferably 0.3 mm or less.

Examples of the laminate film may include a multilayered film formed by covering a metal layer with a resin layer. Examples of the metal layer include a stainless steel foil, an aluminum foil, and an aluminum alloy foil. As the resin layer, a polymer such as polypropylene (PP), polyethylene (PE), nylon, and polyethylene terephthalate (PET) can be used. A thickness of the laminate film is preferably within a range of 0.01 mm or more and 0.5 mm or less. The thickness of the laminate film is more preferably 0.2 mm or less.

The secondary battery can be used in various forms such as a rectangular shape, a cylindrical shape, a flat type, a thin type, and a coin type. The secondary battery may be a secondary battery having a bipolar structure. The secondary battery having a bipolar structure is advantageous in producing a plurality of serial cells by one cell. The negative electrode terminal is electrochemically stable, for example, in a potential range (vs. Li/Li⁺) of 1 V or more and 3 V or less with respect to the oxidation-reduction potential of lithium, and can be formed of a material having conductivity. Specific examples of the material for the negative electrode terminal include zinc, copper, nickel, stainless steel, or aluminum, and an aluminum alloy containing at least one element selected from the group consisting of Mg, Ti, Zn, Mn, Fe, Cu, and Si. As the material for the negative electrode terminal, zinc or a zinc alloy is preferably used. The negative electrode terminal is preferably made of the same material as that for the negative electrode current collector in order to reduce the contact resistance with the negative electrode current collector (for example, a current collector layer included in a negative electrode structure).

The positive electrode terminal is electrically stable, for example, in a potential range (vs. Li/Li⁺) of 2.5 V or more and 4.5 V or less with respect to the oxidation-reduction potential of lithium, and can be formed of a material having conductivity. Examples of the material for the positive electrode terminal include titanium, aluminum, and an aluminum alloy containing at least one element selected from the group consisting of Mg, Ti, Zn, Mn, Fe, Cu, and Si. The positive electrode terminal is preferably formed of the same material as that for the positive electrode current collector in order to reduce the contact resistance with the positive electrode current collector.

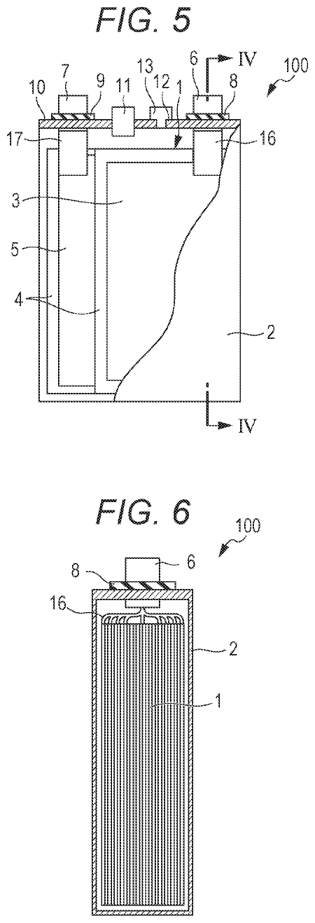

Hereinafter, details of the secondary battery according to the embodiment will be described with reference to FIG. 5 and FIG. 6. FIG. 5 is a cross-sectional view schematically illustrating an example of a secondary battery according to an embodiment. FIG. 6 is a cross-sectional view of the secondary battery illustrated in FIG. 5 taken along line IV-IV.

An electrode group 1 is stored in the exterior package member 2 made of a rectangular tubular metal container. The electrode group 1 includes an electrode structure (negative electrode structure) including a negative electrode 3 and a composite film 4 and a positive electrode 5 as a counter electrode for the negative electrode 3. The electrode group 1 has a structure formed by spirally winding the positive electrode 5 and the negative electrode 3 with the composite film 4 as a separator interposed therebetween so as to form a flat shape while the electrode structure and the positive electrode 5 are arranged. An aqueous electrolyte (not illustrated) is held in the electrode group 1. As illustrated in FIG. 5, a negative electrode lead 16 having a strip shape is electrically connected to each of a plurality of portions at an end of the negative electrode 3 located on an end face of the electrode group 1. A positive electrode lead 17 having a strip shape is electrically connected to each of a plurality of portions at an end of the positive electrode 5 located on the end face. The plurality of negative electrode leads 16 are connected to the negative electrode terminal 6 in a bundled state as illustrated in FIG. 6. Although not illustrated in the drawing, the positive electrode leads 17 are also electrically connected to the positive electrode terminal 7 in a bundled state, similarly.

A sealing plate 10 made of a metal is fixed to an opening portion of the exterior package member 2 made of a metal by welding or the like. The negative electrode terminal 6 and the positive electrode terminal 7 are extracted to the outside from outlet holes provided in the sealing plate 10, respectively. On the inner periphery of each outlet hole of the sealing plate 10, each of a negative electrode gasket 8 and a positive electrode gasket 9 is disposed to avoid a short circuit caused by contact between the negative electrode terminal 6 and the positive electrode terminal 7. By the disposing the negative electrode gasket 8 and the positive electrode gasket 9, the airtightness of a secondary battery 100 can be maintained.

A control valve 11 (safety valve) is disposed in the sealing plate 10. When the internal pressure of a battery cell is increased by a gas generated by electrolysis of the aqueous solvent, the generated gas can be released from the control valve 11. As the control valve 11, for example, a return type valve that operates when the internal pressure exceeds a set value and functions as a sealing plug when the internal pressure lowers can be used. Alternatively, a non-return type control valve that cannot recover the function as a sealing plug once it operates may be used. In FIG. 5, the control valve 11 is disposed at the center of the sealing plate 10, but the position of the control valve 11 may be an end of the sealing plate 10. The control valve 11 may be omitted.

A liquid pouring port 12 is provided in the sealing plate 10. The aqueous electrolyte may be poured via the liquid pouring port 12. The liquid pouring port 12 may be closed by a sealing plug 13 after the aqueous electrolyte is poured. The liquid pouring port 12 and the sealing plug 13 may be omitted.

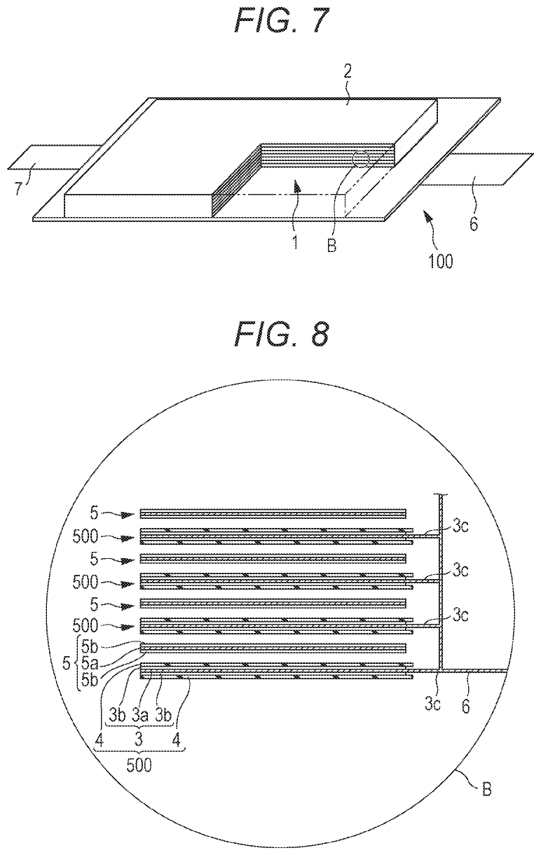

FIG. 7 is a partially cut-out perspective view schematically illustrating another example of the secondary battery according to the embodiment. FIG. 8 is an enlarged cross-sectional view of section B of the secondary battery illustrated in FIG. 7. FIG. 7 and FIG. 8 illustrate an example of the secondary battery 100 using an exterior package member made of a laminate film as an exterior package member.

The secondary battery 100 illustrated in FIG. 7 and FIG. 8 includes an electrode group 1 illustrated in FIG. 7 and FIG. 8, an exterior package member 2 illustrated in FIG. 7, and an aqueous electrolyte, which is not illustrated. The electrode group 1 and the aqueous electrolyte are housed in the exterior package member 2. The aqueous electrolyte is held in the electrode group 1.

The exterior package member 2 is made of a laminate film including two resin layers and a metal layer sandwiched between the resin layers.

As illustrated in FIG. 8, the electrode group 1 is a stacked electrode group. The laminate-type electrode group 1 has a structure in which electrode structures 500 and positive electrodes 5 are alternately laminated.

The electrode group 1 includes a plurality of the electrode structures 500. Each of the electrode structures 500 includes a negative electrode 3 and a composite film 4 supported on both surfaces of the negative electrode 3. Each negative electrode 3 includes a negative electrode current collector layer 3a and negative electrode active material-containing layers 3b disposed on both surfaces of the negative electrode current collector layer 3a. Each composite film 4 is supported on the negative electrode active material-containing layer 3b of the negative electrode 3. The electrode group 1 includes a plurality of the positive electrodes 5. Each of the plurality of the positive electrodes 5 includes a positive electrode current collector 5a and positive electrode active material-containing layers 5b supported on both surfaces of the positive electrode current collector 5a.

The negative electrode current collector layer 3a of each negative electrode 3 includes, at its side, a portion 3c where the negative electrode active material-containing layer 3b is not provided on any surface. The portion 3c serves as a negative electrode current collector tab. As illustrated in FIG. 8, the portion 3c serving as a negative electrode current collector tab does not overlap the positive electrode 5. A plurality of the negative electrode current collector tabs (portions 3c) are electrically connected to the negative electrode terminal 6 having a strip shape. A leading end of the negative electrode terminal 6 having a strip shape is drawn to the outside from the exterior package member 2.

Although not illustrated, the positive electrode current collector 5a of each positive electrode 5 includes, at its side, a portion where the positive electrode active material-containing layer 5b is not supported on any surface. The portion serves as a positive electrode current collector tab. The positive electrode current collector tab does not overlap the negative electrode 3 similarly to the negative electrode current collector tab (portion 3c). The positive electrode current collector tab is located on an opposite side of the electrode group 1 with respect to the negative electrode current collector tab (portion 3c). The positive electrode current collector tab is electrically connected to the positive electrode terminal 7 having a strip shape. A leading end of the positive electrode terminal 7 having a strip shape is located on a side opposite to the negative electrode terminal 6 and is drawn to the outside of the exterior package member 2.

The secondary battery according to the second embodiment includes: the integrated sheet structure of the first embodiment; an electrolyte; a first current collector; and a second current collector, in which the first current collector is located on a first-a main surface of the first mixture layer on a side opposite to a first-b main surface on which the first mixture layer and the third mixture layer are bonded each other, and the second current collector is located on a second-a main surface of the second mixture layer on a side opposite to a second-b main surface on which the second mixture layer and the third mixture layer are bonded each other. Therefore, in the secondary battery, an increase in resistance is suppressed.

### Third Embodiment

According to a third embodiment, there is provided an assembled battery. The assembled battery includes a plurality of the secondary batteries according to the second embodiment.

In the assembled battery according to the embodiment, respective single batteries may be electrically arranged in series or in parallel or may be arranged in a combination of series connection and parallel connection.

Next, an example of the assembled battery will be described with reference to the drawings.

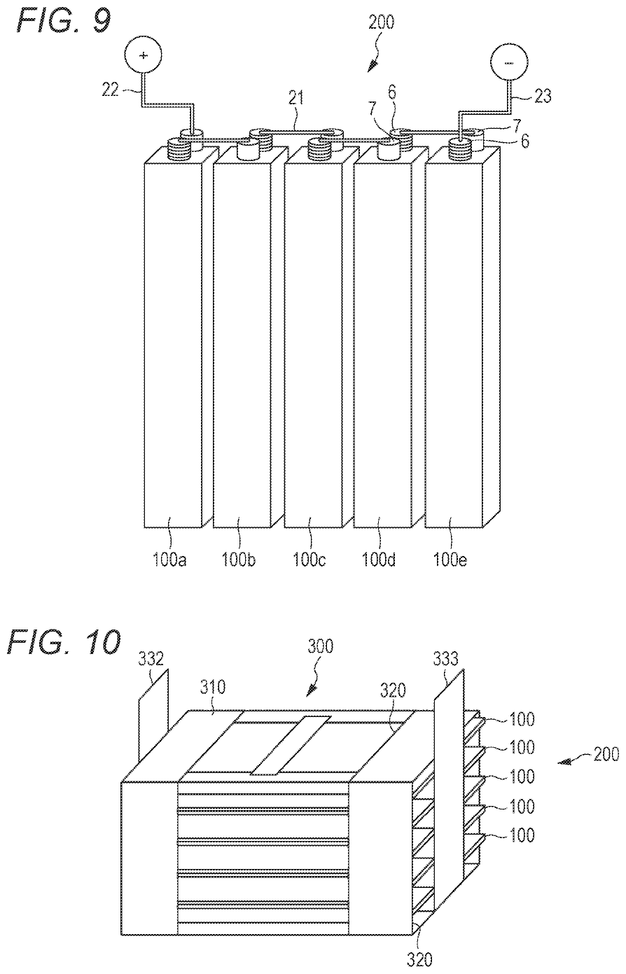

FIG. 9 is a perspective view schematically illustrating an example of an assembled battery according to an embodiment. An assembled battery 200 illustrated in FIG. 9 includes five single batteries 100a to 100e, four bus bars 21, a positive electrode side lead 22, and a negative electrode side lead 23. Each of the five single batteries 100a to 100e is a secondary battery according to the third embodiment.

Each bus bar 21 connects, for example, a negative electrode terminal 6 of one single battery 100a and a positive electrode terminal 7 of the single battery 100b located adjacent to the single battery 100a. In this way, the five single batteries 100 are connected in series by the four bus bars 21. That is, the assembled battery 200 in FIG. 9 is an assembled battery of five in-series connection. Although an example is not illustrated, in an assembled battery including a plurality of single batteries electrically connected in parallel, for example, a plurality of negative electrode terminals are connected to one another by bus bars and a plurality of positive electrode terminals are connected to one another by bus bars, so that the plurality of single batteries can be electrically connected.

The positive electrode terminal 7 of at least one battery of the five single batteries 100a to 100e is electrically connected to the positive electrode side lead 22 for external connection. The negative electrode terminal 6 of at least one battery of the five single batteries 100a to 100e is electrically connected to the negative electrode side lead 23 for external connection.

As described above, the assembled battery according to the embodiment includes the secondary battery according to the second embodiment. Therefore, in the assembled battery, an increase in resistance is suppressed.

### Fourth Embodiment

According to a fourth embodiment, there is provided a battery pack including the secondary battery according to the second embodiment. This battery pack can include the assembled battery according to the third embodiment. This battery pack may include the single secondary battery according to the second embodiment instead of the assembled battery according to the third embodiment.

Such a battery pack can further include a protective circuit. The protective circuit has a function to control charging and discharging of the secondary battery. Alternatively, a circuit included in a device using a battery pack as a power supply (for example, an electronic device, an automobile, or the like) may be used as the protective circuit of the battery pack.

The battery pack can also further include an external power distribution terminal. The external power distribution terminal is configured to externally output current from the secondary battery and/or to input external current into the secondary battery. In other words, when the battery pack is used as a power supply, the current is supplied to the outside via the external power distribution terminal. When the battery pack is charged, the charging current (including regenerative energy of motive force of an automobile or the like) is supplied to the battery pack via the external power distribution terminal.

Next, an example of the battery pack according to the embodiment will be described with reference to the drawings.

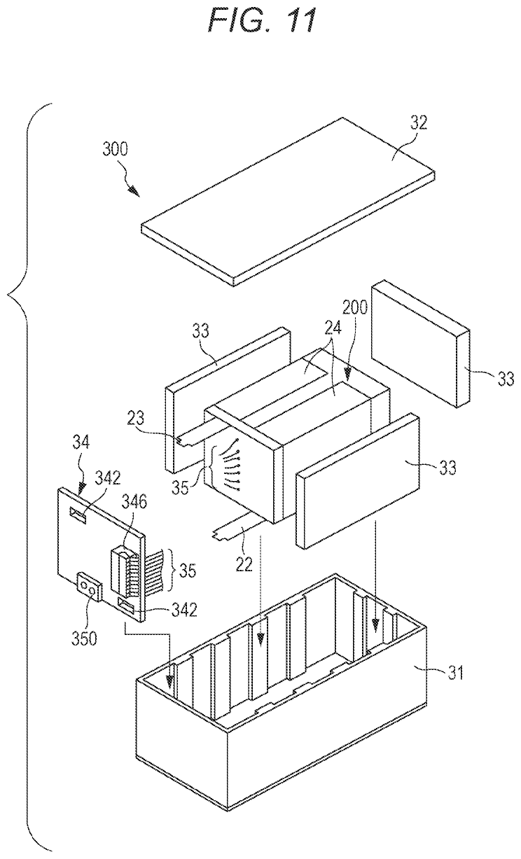

FIG. 10 is a perspective view schematically illustrating an example of a battery pack according to an embodiment.

A battery pack 300 includes, for example, an assembled battery including the secondary batteries illustrated in FIG. 7 and FIG. 8. The battery pack 300 includes a housing 310 and an assembled battery 200 housed in the housing 310. In the assembled battery 200, a plurality of (for example, five) secondary batteries 100 are electrically connected in series. The secondary batteries 100 are stacked in a thickness direction. The housing 310 has opening portions 320 on an upper portion and four side surfaces, respectively. The side surface on which the negative electrode terminal 6 and the positive electrode terminal 7 of each secondary battery 100 protrude is exposed on the opening portion 320 of the housing 310. An output positive electrode terminal 332 of the assembled battery 200 has a strip shape and has one end electrically connected to the positive electrode terminal 7 of any of the secondary batteries 100 and the other end protruding from the opening portion 320 of the housing 310 to protrude from the upper portion of the housing 310. On the other hand, an output negative electrode terminal 333 of the assembled battery 200 has a strip shape and has one end electrically connected to the negative electrode terminal 6 of any of the secondary batteries 100 and the other end protruding from the opening portion 320 of the housing 310 to protrude from the upper portion of the housing 310.

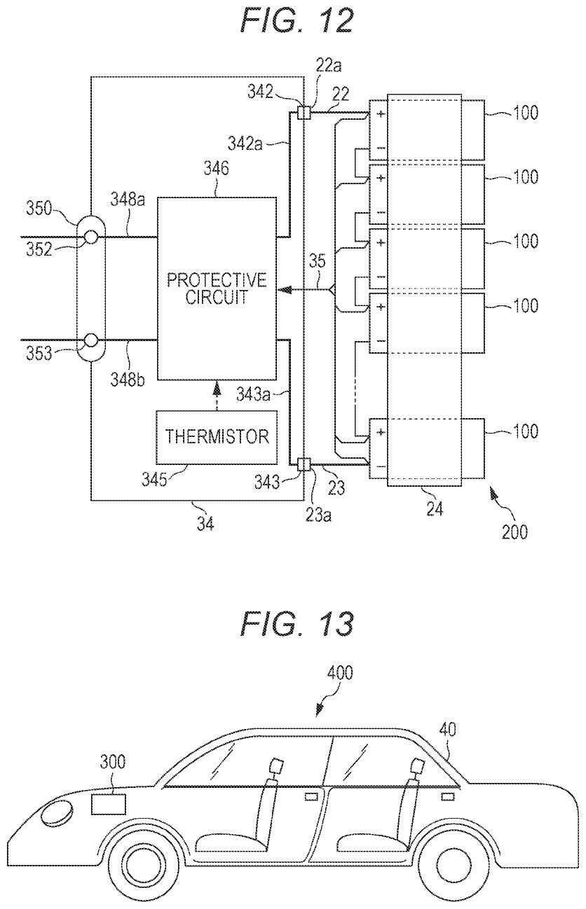

Other examples of such a battery pack will be described with reference to FIG. 11 and FIG. 12. FIG. 11 is an exploded perspective view schematically illustrating another example of the battery pack according to the embodiment. FIG. 12 is a block diagram illustrating an example of an electric circuit of the battery pack illustrated in FIG. 11.

The battery pack 300 illustrated in FIG. 11 and FIG. 12 includes a housing container 31, a lid 32, protective sheets 33, an assembled battery 200, a printed wiring board 34, wires 35, and an insulating plate (not illustrated).

The housing container 31 illustrated in FIG. 11 is a square bottomed container having a rectangular bottom surface. The housing container 31 is configured to be capable of housing the protective sheets 33, the assembled battery 200, the printed wiring board 34, and the wires 35. The lid 32 has a rectangular shape. The lid 32 covers the housing container 31 to house the assembled battery 200 and the like. The housing container 31 and the lid 32 are provided with opening portions, connection terminals, or the like (not illustrated) for connection to an external device or the like.

The assembled battery 200 includes a plurality of single batteries 100, a positive electrode side lead 22, a negative electrode side lead 23, and an adhesive tape 24.

At least one of the plurality of single batteries 100 is the secondary battery according to the embodiment. The plurality of single batteries 100 are electrically connected in series as illustrated in FIG. 12, respectively. The plurality of single batteries 100 may be electrically connected in parallel or may be connected in a combination of series connection and parallel connection. When the plurality of single batteries 100 are connected in parallel, the battery capacity increases as compared to a case where the plurality of single batteries are connected in series.

The adhesive tape 24 fastens the plurality of single batteries 100. The plurality of single batteries 100 may be fixed using a heat-shrinkable tape instead of the adhesive tape 24. In this case, the protective sheet 33 are arranged on both side surfaces of the assembled battery 200, and the heat-shrinkable tape is wound around the assembled battery 200 and the protective sheets 33, and then the heat-shrinkable tape is shrunk by heating to bundle the plurality of single batteries 100.

One end of the positive electrode side lead 22 is connected to the assembled battery 200. One end of the positive electrode side lead 22 is electrically connected to the positive electrode of one or more single batteries 100. One end of the negative electrode side lead 23 is connected to the assembled battery 200. One end of the negative electrode side lead 23 is electrically connected to the negative electrode of one or more single batteries 100.

The printed wiring board 34 is disposed on the one inner surface along the short-side direction of inner surfaces of the housing container 31. The printed wiring board 34 includes a positive electrode side connector 342, a negative electrode side connector 343, a thermistor 345, a protective circuit 346, wires 342a and 343a, an external power distribution terminal 350, a plus-side wire (positive side wire) 348a, and a minus-side wire (negative side wire) 348b. One main surface of the printed wiring board 34 faces one side surface of the assembled battery 200. An insulating plate (not illustrated) is disposed between the printed wiring board 34 and the assembled battery 200.

The other end 22a of the positive electrode side lead 22 is electrically connected to the positive electrode side connector 342. The other end 23a of the negative electrode side lead 23 is electrically connected to the negative electrode side connector 343.

The thermistor 345 is fixed to one main surface of the printed wiring board 34. The thermistor 345 detects the temperature of each single battery 100 and transmits detection signals to the protective circuit 346.

The external power distribution terminal 350 is fixed to the other main surface of the printed wiring board 34. The external power distribution terminal 350 is electrically connected to a device that exists outside the battery pack 300. The external power distribution terminal 350 includes a positive side terminal 352 and a negative side terminal 353.

The protective circuit 346 is fixed to the other main surface of the printed wiring board 34. The protective circuit 346 is connected to the positive side terminal 352 via the plus-side wire 348a. The protective circuit 346 is connected to the negative side terminal 353 via the minus-side wire 348b. The protective circuit 346 is electrically connected to the positive electrode side connector 342 via the wire 342a. The protective circuit 346 is electrically connected to the negative electrode side connector 343 via the wire 343a. The protective circuit 346 is electrically connected to each of the plurality of single batteries 100 via the wires 35.

The protective sheets 33 are disposed on both inner surfaces of the housing container 31 along the long-side direction and on the inner surface along the short-side direction, facing the printed wiring board 34 across the assembled battery 200. The protective sheets 33 are made of, for example, a resin or rubber.

The protective circuit 346 controls charging and discharging of the plurality of single batteries 100. The protective circuit 346 is also configured to cut-off electric connection between the protective circuit 346 and the external power distribution terminal 350 (the positive side terminal 352 and the negative side terminal 353) to external devices, based on detection signals transmitted from the thermistor 345 or detection signals transmitted from each single battery 100 or the assembled battery 200.

As the detection signal transmitted from the thermistor 345, for example, a signal indicating that the temperature of the single battery 100 is detected to be a predetermined temperature or more. As the detection signal transmitted from each single battery 100 or the assembled battery 200, for example, a signal indicating detection of over-charge, over-discharge, and overcurrent of the single battery 100. When over-charge or the like is detected for each single battery 100, the battery voltage may be detected, or a positive electrode potential or a negative electrode potential may be detected. In the latter case, a lithium electrode to be used as a reference electrode is inserted into each single battery 100.

As the protective circuit 346, a circuit included in a device using the battery pack 300 as a power supply (for example, an electronic device, an automobile, or the like) may be used.

As described above, the battery pack 300 includes the external power distribution terminal 350. Therefore, the battery pack 300 can output current from the assembled battery 200 to an external device and input current from an external device to the assembled battery 200 via the external power distribution terminal 350. In other words, when the battery pack 300 is used as a power supply, the current from the assembled battery 200 is supplied to an external device via the external power distribution terminal 350. When the battery pack 300 is charged, the charging current from an external device is supplied to the battery pack 300 via the external power distribution terminal 350. When the battery pack 300 is used as an onboard battery, the regenerative energy of motive force of a vehicle can be used as the charging current from the external device.

The battery pack 300 may include a plurality of assembled batteries 200. In this case, the plurality of assembled batteries 200 may be connected in series, may be connected in parallel, or may be connected in a combination of series connection and parallel connection. The printed wiring board 34 and the wire 35 may be omitted. In this case, the positive electrode side lead 22 and the negative electrode side lead 23 may be used as the positive side terminal and the negative side terminal of the external power distribution terminal, respectively.

Such a battery pack is used, for example, in applications where excellent cycle performance is demanded when a large current is extracted. Specifically, the battery pack is used as, for example, a power supply for electronic devices, a stationary battery, or an onboard battery for various vehicles. Examples of the electronic devices may include a digital camera. The battery pack is particularly suitably used as an onboard battery.

The battery pack according to the fourth embodiment includes the secondary battery according to the second embodiment or the assembled battery according to the third embodiment. Therefore, in the battery pack, an increase in resistance is suppressed.

### Fifth Embodiment

According to a fifth embodiment, there is provided a vehicle including the battery pack according to the fourth embodiment.

In such a vehicle, the battery pack is configured, for example, to recover regenerative energy from motive force of the vehicle. The vehicle may include a mechanism (regenerator) configured to convert kinetic energy of the vehicle into regenerative energy.

Examples of the vehicle according to the embodiment include two- to four-wheeled hybrid electric automobiles, two- to four-wheeled electric automobiles, electrically assisted bicycles, and railway vehicles.

The installing position of the battery pack in the vehicle according to the embodiment is not particularly limited. For example, when the battery pack is installed in an automobile, the battery pack can be installed in an engine compartment of the vehicle, in the rear part of the vehicle, or under a seat.

The vehicle according to the embodiment may include a plurality of battery packs installed. In this case, batteries included in the respective battery packs may be electrically connected in series, may be electrically connected in parallel, or may be electrically connected in a combination of series connection and parallel connection. For example, when the respective battery packs include assembled batteries, the assembled batteries may be electrically connected in series, may be electrically connected in parallel, or may be electrically connected in a combination of series connection and parallel connection. Alternatively, when the respective battery packs include single batteries, the respective batteries may be electrically connected in series, may be electrically connected in parallel, or may be electrically connected in a combination of series connection and parallel connection.

Next, an example of the vehicle according to the embodiment will be described with reference to the drawings.

FIG. 13 is a partial transparent view schematically illustrating an example of a vehicle according to an embodiment. A vehicle 400 illustrated in FIG. 13 includes a vehicle body 40 and a battery pack 300 according to the fifth embodiment. In the example illustrated in FIG. 13, the vehicle 400 is a four-wheeled automobile.

This vehicle 400 may include a plurality of battery packs 300 installed. In this case, batteries included in the battery pack 300 (for example, single batteries or assembled batteries) may be connected in series, may be connected in parallel, or may be connected in a combination of series connection and parallel connection.

An example in which the battery pack 300 is installed in an engine compartment located at the front of the vehicle body 40 is illustrated in FIG. 13. As described above, the battery pack 300 may be installed, for example, in the rear part of the vehicle body 40 or under a seat. The battery pack 300 can be used as a power supply of the vehicle 400. The battery pack 300 can also recover regenerative energy of motive force of the vehicle 400.

The vehicle according to the fifth embodiment includes the battery pack according to the fourth embodiment installed. Thus, the vehicle is excellent in traveling performance and reliability.

### Sixth Embodiment

According to a sixth embodiment, there is provided a stationary power supply including the battery pack according to the fourth embodiment.

Such a stationary power supply may include the assembled battery according to the fourth embodiment or the secondary battery according to the third embodiment, instead of the battery pack according to the fifth embodiment. The stationary power supply according to the embodiment can implement a long life.

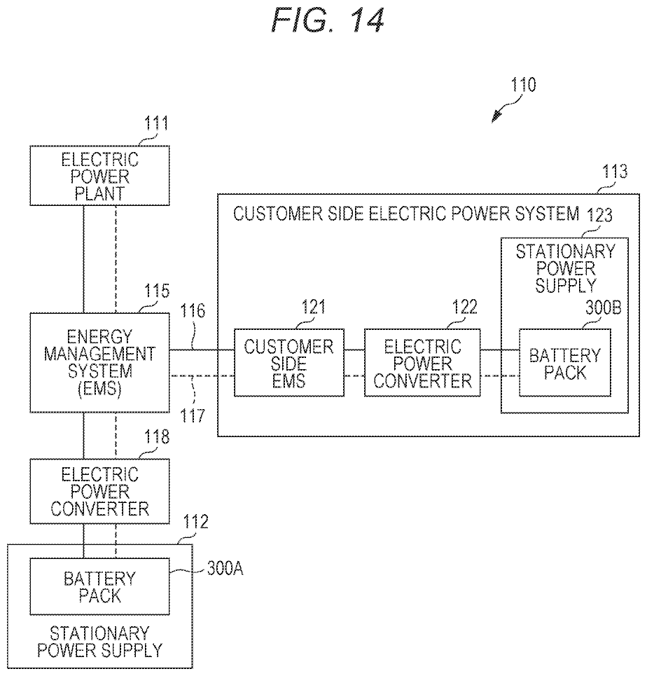

FIG. 14 is a block diagram illustrating an example of a system including a stationary power supply according to an embodiment. FIG. 14 is a diagram illustrating an application example to stationary power supplies 112 and 123 as an example of use of battery packs 300A and 300B according to the embodiment. In an example illustrated in FIG. 14, a system 110 in which the stationary power supplies 112 and 123 are used is illustrated. The system 110 includes an electric power plant 111, a stationary power supply 112, a customer side electric power system 113, and an energy management system (EMS) 115. An electric power network 116 and a communication network 117 are formed in the system 110, and the electric power plant 111, the stationary power supply 112, the customer side electric power system 113, and the EMS 115 are connected via the electric power network 116 and the communication network 117. The EMS 115 performs control to stabilize the entire system 110 by utilizing the electric power network 116 and the communication network 117.

The electric power plant 111 generates a large amount of electric power from fuel sources such as thermal power and nuclear power. Electric power is supplies from the electric power plant 111 through the electric power network 116 and the like. The battery pack 300A is installed in the stationary power supply 112. The battery pack 300A can store electric power and the like supplied from the electric power plant 111. The stationary power supply 112 can supply the electric power stored in the battery pack 300A through the electric power network 116 and the like. The system 110 is provided with an electric power converter 118. The electric power converter 118 includes a converter, an inverter, a transformer, and the like. Thus, the electric power converter 118 can perform conversion between direct current and alternate current, conversion between alternate currents of frequencies different from each other, voltage transformation (step-up and step-down), and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use, and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 though the electric power network 116. The battery pack 300B can store electric power supplied to the customer side electric power system 113. Similarly to the electric power converter 118, the electric power converter 122 includes a converter, an inverter, a transformer, and the like. Thus, the electric power converter 122 can perform conversion between direct current and alternate current, conversion between alternate currents of frequencies different from each other, voltage transformation (step-up and step-down), and the like. Therefore, the electric power converter 122 can convert electric power supplied to the customer side electric power system 113 into electric power that can be stored in the battery pack 300B.

The electric power stored in the battery pack 300B can be used, for example, for charging a vehicle such as an electric automobile. The system 110 may be provided with a natural energy source. In this case, the natural energy source generates electric power by natural energy such as wind power and solar light. In addition to the electric power plant 111, electric power is also supplied from the natural energy source through the electric power network 116.

### EXAMPLES

### Example 1

<Production of Integrated Sheet Structure>

First, as the first current collector, a Zn foil having a thickness of 50 μm was prepared. Next, a slurry for forming a first mixture layer was applied onto the Zn foil by a doctor blade method. The slurry for forming a first mixture layer was obtained by mixing an active material, a conductive agent, a binder, and a solvent. As the active material, Li₄Ti₅O₁₂ was used. As the conductive agent, a graphite powder was used. As the binder, polyvinyl butyral was used. As the solvent, N-methyl-2-pyrrolidone (NMP) was used. The mass ratio of the active material, the conductive agent, and the binder in the slurry was set to 100:5:1. The coating film thus obtained was dried at a temperature of 120° C. for 5 minutes.

Next, a slurry for forming a third mixture layer was applied onto the first mixture layer. The slurry for forming a third mixture layer was obtained by mixing inorganic solid particles and a polymeric material (binder) with N-methyl-2-pyrrolidone (NMP). LATP (Li_{1.5}Al_{0.5}Ti_{1.5}(PO₄)₃) was used as the inorganic solid particles, and polyvinyl butyral was used as the polymeric material. A softening point of the polyvinyl butyral was 120° C. In the slurry, the mass ratio of the inorganic solid particles and the polymeric material was set to 88:12. This slurry was applied onto one main surface of the first mixture layer on a side opposite to the Zn foil by a doctor blade method, and the coating film thus obtained was dried at a temperature of 120° C. for 5 minutes.

In the third mixture layer, a slurry for forming the second mixture layer was applied onto one main surface on a side opposite to the main surface onto which the first mixture layer had been applied. The slurry for forming a second mixture layer was obtained by mixing an active material, a conductive agent, a binder, and a solvent. As the active material, LiMn₂O₄ was used. As the conductive agent, a graphite powder was used. As the binder, PVdF was used. As the solvent, NMP was used. The mass ratio of the active material, the conductive agent, and the binder in the slurry was set to 80:10:10. The slurry was applied onto the third mixture layer by the above-described method and dried at a temperature of 120° C. for 5 minutes. Thereafter, a laminate of the first mixture layer, the second mixture layer, and the third mixture layer was subjected to a roll pressing treatment to obtain an integrated sheet structure. In the present application, as described above, the first mixture layer was applied onto one main surface of the third mixture layer, the second mixture layer was applied onto the other main surface, and finally, a roll pressing treatment was performed. Thereby, in the integrated sheet structure of the present application, the first mixture layer and the third mixture layer are bonded each other, and the second mixture layer and the third mixture layer are bonded each other. This is because each of the first mixture layer, the second mixture layer, and the third mixture layer is a mixture layer containing solid particles and a binder. When each mixture layer contains the solid particles and the binder described above, there are many contact points between the respective layers at the interface between the first mixture layer and the third mixture layer and the interface between the third mixture layer and the second mixture layer. By roll pressing a laminate in which the first mixture layer, the second mixture layer, and the third mixture layer are laminated, the gaps at the above-described interface are reduced and the contact points between the respective layers are increased, so that an integrated sheet structure as described in the present application is obtained.

<Production of Battery>

The integrated sheet structure was impregnated with the aqueous electrolyte by immersing the integrated sheet structure obtained above in an aqueous electrolyte separately prepared. The aqueous electrolyte was prepared by mixing an electrolyte salt and water. As the electrolyte salt, lithium chloride was used. The concentration of the electrolyte salt in the aqueous electrolyte was set to 10 mol/L.

Thereafter, a Ti foil having a thickness of 12 μm was set on the second mixture layer surface and subjected to the roll pressing treatment again. Thereby, the battery was produced.

One battery to be measured in order of a constant current charge-discharge test, coulombic efficiency evaluation, and a 180-degree peeling test described below and one battery to be measured in order of a constant current charge-discharge test, coulombic efficiency evaluation, and measurement of the content ratio of each binder in each mixture layer, that is, two batteries in total were produced by the method for producing a battery described above.

<Constant Current Charge-Discharge Test>

For each battery produced in Examples 1 to 5 and Comparative Examples 1 to 3, after production of a test battery, the test was started immediately without a waiting time. Both charging and discharging were performed at a rate of 0.5 C. At the time of charge, earlier time of a time until the current value reaches 0.25 C, a time until the charging time reaches 130 minutes, and a time until the charging capacity reaches 170 mAh/g was regarded as a termination condition. At the time of discharge, a lapse of 130 minutes was regarded as a termination condition.

<Coulombic Efficiency Evaluation>

For the respective batteries prepared in Examples 1 to 5 and Comparative Examples 1 to 3, the coulombic efficiency was evaluated as described below.

An operation in which the charging and discharging performed in the constant current charge-discharge test is performed once was regarded as one cycle, the coulombic efficiency was calculated using the following equation from the charging capacity and the discharging capacity at the 20th cycle. Coulombic efficiency (%)=100×(Discharging capacity/Charging capacity). The measurement and calculation are performed for the two batteries in total described in the production of the battery, and the results of averaging the coulombic efficiencies in the respective batteries are shown in Table 1.

<Measurement Method of 180-Degree Peeling Test>

After the secondary battery obtained in the production of a battery described above was discharged, the secondary battery was disassembled in the air and the electrode was extracted. The discharge state refers to a state where the battery is charged until the charging rate is 0%. The extracted electrode was immersed in pure water for 3 minutes and then dried at 100° C. for 5 minutes. Thereafter, the current collector was removed from the electrode to obtain an integrated sheet structure.

The obtained integrated sheet structure was measured in a 180-degree peeling test. The measurement method is as follows. First, the integrated sheet structure of the first mixture layer, the second mixture layer, and the third mixture layer was cut into a width of 2 cm×a length of 5 cm. Next, one side of a double-sided tape having a width of 2 cm×a length of 2.5 cm was pasted to cover one side surface of the integrated sheet structure and the other surface of the double-sided tape was pasted onto a base. At this time, the double-sided tape was not pasted to a portion having a width of 2 cm×a length of 2.5 cm that is the other half of the one side surface of the integrated sheet structure. Thereafter, the portion of the integrated sheet structure to which the double-sided tape is not pasted was bent so as to be parallel to the base. Next, the base was set on a peeling strength tester, and the portion of the integrated sheet structure to which the double-sided tape was not pasted was attached to a sample fixation portion of the peeling strength tester. As a measurement condition, a peeling strength (N/20 mm) of the integrated sheet structure was measured at a speed (pulling speed) of 20 mm/min. The peeling strength of the integrated sheet structure in the 180-degree peeling test in this example obtained by the measurement method is shown in Table 1.

<Measurement of Content Ratio of Each Binder in Each Mixture Layer>

An integrated sheet structure was obtained, by the treatment operation in which electrode is extracted from the secondary battery described in the measurement method of the peeling strength to remove the current collector thereby obtaining an integrated sheet structure. The obtained integrated sheet structure was subjected to the cross-section processing with ion milling, the cross-section observation was performed, and then the fluorine concentration in each mixture layer was calculated. As for a place where the integrated sheet structure is subjected to cross-section processing, the cross-section processing was performed three times at a position where a side corresponding to a long side of a substantially quadrangular shape is divided into equal quarters when the integrated sheet structure is viewed in plan view. The cross-section observation of the integrated sheet structure was performed with a SEM-EDX. As a device, SU-8020 manufactured by Hitachi High-Technologies Corporation was used, and then the acceleration voltage was set to 15 kV. As an observation region in area analysis for each of the first, second, and the third mixture layers, a region where the first, second, and third mixture layers exist when the cross-section is viewed in a lamination direction was selected. Next, the cross-section was imaged at a magnification that the entirety of each mixture layer is included in the observation region in the selected region, and a bonding interface between the mixture layers and surface were excluded. Three processed cross-sections each were imaged and measured. By measuring the fluorine concentration in each mixture layer for each cross-section of the integrated sheet structure under the above-described condition and averaging the fluorine concentrations in respective images, the fluorine concentration in each mixture layer measured was calculated. In this example, the fluorine concentration contained in the third mixture layer was 12 times the fluorine concentration contained in the first mixture layer and the fluorine concentration contained in the second mixture layer. Hereinafter, also in Examples 2 to 5 and Comparative Examples 1 and 3, the same measurement was performed. The measurement of the content ratio of each binder in each mixture layer in Comparative Example 2 will be described in the section of Comparative Example 2.

### Example 2

A battery was produced in the same manner as in Example 1, except that the mass ratio of the inorganic solid particles and the polymeric material of the third mixture layer in the integrated sheet structure described in Example 1 was set to 95:5. The content ratio of each binder in each mixture layer was measured in the same manner as in Example 1, and the fluorine concentration contained in the third mixture layer was 5 times the fluorine concentration contained in the first mixture layer and the fluorine concentration contained in the second mixture layer.

### Example 3

A battery was produced in the same manner as in Example 1, except that the mass ratio of the inorganic solid particles and the polymeric material of the third mixture layer in the integrated sheet structure described in Example 1 was set to 97:3. The content ratio of each binder in each mixture layer was measured in the same manner as in Example 1, and the fluorine concentration contained in the third mixture layer was 3 times the fluorine concentration contained in the first mixture layer and the fluorine concentration contained in the second mixture layer.

### Example 4

A battery was produced in the same manner as in Example 1, except that the mass ratio of the inorganic solid particles and the polymeric material of the third mixture layer in the integrated sheet structure described in Example 1 was set to 98:2. The content ratio of each binder in each mixture layer was measured in the same manner as in Example 1, and the fluorine concentration contained in the third mixture layer was 2 times the fluorine concentration contained in the first mixture layer and the fluorine concentration contained in the second mixture layer.

### Example 5

A battery was produced in the same manner as in Example 1, except that the mass ratio of the inorganic solid particles and the polymeric material of the third mixture layer in the integrated sheet structure described in Example 1 was set to 99:1. The content ratio of each binder in each mixture layer was measured in the same manner as in Example 1, and the fluorine concentration contained in the third mixture layer was 1 time the fluorine concentration contained in the first mixture layer and the fluorine concentration contained in the second mixture layer.

### Comparative Example 1

A battery was produced in the same manner as in Example 1, except that the mass ratio of the inorganic solid particles and the polymeric material of the third mixture layer in the integrated sheet structure described in Example 1 was set to 88:12, the third mixture layer was applied onto the first mixture layer, the second mixture layer was applied to a titanium foil, the second mixture layer was then laminated on the third mixture layer so that the surface of the second mixture layer on a side opposite to the surface on which the titanium foil was provided was in contact with the surface of the third mixture layer on a side opposite to the surface on which the first mixture layer was provided, and the roll pressing treatment was not performed. The content ratio of each binder in each mixture layer was measured in the same manner as in Example 1, and the fluorine concentration contained in the third mixture layer was 12 times the fluorine concentration contained in the first mixture layer and the fluorine concentration contained in the second mixture layer.

### Comparative Example 2

In Comparative Example 2, the third mixture layer has a substrate layer and has two composite layers in total, each of the composite layers being provided on the surface of the third mixture layer in contact with the first mixture layer and on the surface of the third mixture layer in contact with the second mixture layer.

First, a cellulose-based nonwoven fabric having a thickness of 15 μm was prepared as the substrate layer in the third mixture layer. Next, the mass ratio of the inorganic solid particles and the polymeric material of the slurry for forming the third mixture layer described in Example 1 was set to 88:12 and the slurry was applied onto the third mixture layer and dried to obtain a composite layer. The same slurry for forming the third mixture layer was applied onto the surface of the third mixture layer on a side opposite to the composite layer and dried to obtain an additional composite layer. Next, a battery was produced in the same manner as in Example 1, except that the first mixture layer described in Example 1 was applied onto a Zn foil, the second mixture layer was applied to a Ti foil, lamination was performed so that the first mixture layer and the third mixture layer were in contact with each other, and the second mixture layer and the third mixture layer were in contact with each other, and the roll pressing treatment was not performed.

As for the measurement of the content ratio of each binder in each mixture layer, the cross-section processing was performed in the same manner as in Example 1, and a region where the first, second, and third mixture layers exist when the cross-section is viewed in a lamination direction was selected. Next, for the first and second mixture layers, similarly, the cross-section was imaged at a magnification that the entirety of each mixture layer is included in the observation region in the selected region, and a bonding interface between the mixture layers and surface were excluded. For the third mixture layer, since there were two composite layers on the first mixture layer side and the second mixture layer side, the cross-section was imaged once for each composite layer, twice in total, at such a magnification that only each composite layer is included in the observation region in the selected region. The fluorine concentrations obtained in the two mixture layers were averaged to obtain the content ratio of the third binder in the third mixture layer in the cross-section.

By measuring the fluorine concentration in each mixture layer for each cross-section of the electrode group in the battery of Comparative Example 2 under this condition and averaging the fluorine concentrations in respective images, the fluorine concentration in each mixture layer measured was calculated. As a result, the fluorine concentration contained in the third mixture layer was 12 times the fluorine concentration contained in the first mixture layer and the fluorine concentration contained in the second mixture layer.

### Comparative Example 3

A battery was produced in the same manner as in Example 1, except that the mass ratio of the inorganic solid particles and the polymeric material of the third mixture layer in the integrated sheet structure described in Example 1 was set to 99:1, the third mixture layer was applied onto the first mixture layer, the second mixture layer was applied to a titanium foil, the second mixture layer was then laminated on the third mixture layer so that the surface of the second mixture layer on a side opposite to the surface on which the titanium foil was provided was in contact with the surface of the third mixture layer on a side opposite to the surface on which the first mixture layer was provided, and the roll pressing treatment was not performed. The content ratio of each binder in each mixture layer was measured in the same manner as in Example 1, and the fluorine concentration contained in the third mixture layer was 1 time the fluorine concentration contained in the first mixture layer and the fluorine concentration contained in the second mixture layer.

In Examples 2 to 5 and Comparative Examples 1 to 3, the 180-degree peeling test, the measurement of the amount of the binder in the integrated sheet structure, and the coulombic efficiency evaluation were performed in the same manner as in Example 1. The respective results are described in Table 1.

TABLE 1

| | Whether or not | Peeling | Coulombic |
|---|---|---|---|
| | battery is integrated | strength | efficiency [%] |
| Example | sheet structure | [N/20 mm] | at 20th cycle |
| Example 1 | ◯ | 100 | 96 |
| Example 2 | ◯ | 72 | 95 |
| Example 3 | ◯ | 61 | 94 |
| Example 4 | ◯ | 60 | 93 |
| Example 5 | ◯ | 52 | 93 |
| Comparative | X | — | 90 |
| Example 1 | | | |
| Comparative | X | — | 89 |
| Example 2 | | | |
| Comparative | X | — | 85 |
| Example 3 | | | |

In Table 1, whether or not the battery in each example is the integrated sheet structure is represented as “O” or “x”

From comparison between Examples 1 to 5 and Comparative Examples 1 to 3, it is found that, with the integrated sheet structure, the coulombic efficiency becomes higher in the batteries of Examples 1 to 5 than in Comparative Examples 1 to 3. This is because, when the bonding at the interfaces between the first and second mixture layers functioning as electrodes and the third mixture layer as a separator is high, generation of liquid accumulation of water derived from the aqueous electrolyte at the interfaces therebetween can be suppressed. That is, since proceeding of the electrolysis reaction of water in this liquid accumulation can be suppressed and an increase in resistance as the secondary battery due to a change in a distance between electrodes caused by the generated gas can be suppressed, the coulombic efficiency is high in Examples 1 to 5.

It is found that, in Comparative Examples 1 and 3, the first mixture layer and the third mixture layer are in contact with each other, but since liquid accumulation as described above occurs at the interface between the second mixture layer and the third mixture layer, the coulombic efficiency in Examples 1 to 5 that are the integrated sheet structures is high.

From comparison between Examples 1 to 5 and comparison between Comparative Examples 1 to 3, it is found that the peeling strength increases as the fluorine concentration in the third mixture layer is larger than the fluorine concentration in the first mixture layer and the fluorine concentration in the second mixture layer, so that the coulombic efficiency becomes higher. This is because, when the content ratio of the third binder in the third mixture layer is large, the bonding at the interface between the first mixture layer and the third mixture layer and the interface between the second mixture layer and the third mixture layer can be further increased. This is because, when the content ratio of the third binder in the third mixture layer is larger than the content ratio of the second binder in the second mixture layer and the content ratio of the first binder in the first mixture layer, liquid accumulation as described above can be further suppressed. Since further expansion of gaps caused by gas generation at the time of charge can be further suppressed, gas accumulation, which is one of causes of increasing resistance, can be prevented from occurring, and a decrease in coulombic efficiency can be further suppressed.

While certain embodiments of the present invention have been described, these embodiments have been presented by way of example only, and are not intended to limit the scope of the inventions. These novel embodiments can be embodied in a variety of other forms, various omissions, substitutions and changes in the form of the embodiments may be made without departing from the spirit of the inventions. The accompanying claims and their equivalents are intended to cover these embodiments or modifications thereof as would fall within the scope and spirit of the inventions.

Hereinafter, some features according to the embodiments will be added.
[1] An integrated sheet structure for a secondary battery, including: a first mixture layer containing a first active material and a first binder; a second mixture layer containing a second active material and a second binder; and a third mixture layer located between the first mixture layer and the second mixture layer and containing solid particles and a third binder, in which the first mixture layer and the third mixture layer are bonded each other, and the second mixture layer and the third mixture layer are bonded each other.
[2] The integrated sheet structure described in [1], in which a peeling strength of the integrated sheet structure as measured in a 180-degree peeling test is 50 N/20 mm or more (50 N or more at a pulling speed of 20 mm/min).
[3] The integrated sheet structure described in [1] or [2], wherein a content ratio of the third binder in the third mixture layer is larger than a content ratio of the second binder in the second mixture layer and a content ratio of the first binder in the first mixture layer.
[4] A secondary battery including: the integrated sheet structure described in any one of [1] to [3]; an electrolyte; a first current collector; and a second current collector, in which the first current collector is located on a first-a main surface of the first mixture layer on a side opposite to a first-b main surface on which the first mixture layer and the third mixture layer are bonded each other, and the second current collector is located on a second-a main surface of the second mixture layer on a side opposite to a second-b main surface on which the second mixture layer and the third mixture layer are bonded each other.
[5] The secondary battery described in [4], in which the secondary battery has a negative electrode, a positive electrode, and a separator, the negative electrode includes the first mixture layer and the first current collector, the positive electrode includes the second mixture layer and the second current collector, and the separator is the third mixture layer.
[6] An aqueous secondary battery including the secondary battery described in [4] or [5] wherein the electrolyte is an aqueous electrolyte.
[7] A battery pack including the secondary battery described in [4] or [5] or the aqueous secondary battery described in [6].
[8] The battery pack described in [7], further including: an external power distribution terminal; and a protective circuit.
[9] The battery pack described in [7] or [8], in which the battery pack includes a plurality of the secondary batteries, and the plurality of the secondary batteries are electrically connected in series, in parallel, or in combination of series and parallel.
[10] A vehicle including the battery pack described in any one of [7] to [9].
[11] The vehicle described in [10], in which the vehicle includes a mechanism configured to convert kinetic energy of the vehicle into regenerative energy.
[12] A stationary power supply including the battery pack described in any one of [7] to [9].

What is claimed is:

1. An integrated sheet structure for a secondary battery, comprising:
a first mixture layer containing a first active material and a first binder;
a second mixture layer containing a second active material and a second binder; and
a third mixture layer located between the first mixture layer and the second mixture layer and containing solid particles and a third binder,
wherein the first mixture layer and the third mixture layer are bonded each other, and the second mixture layer and the third mixture layer are bonded each other.

2. The integrated sheet structure according to claim 1, wherein a peeling strength of the integrated sheet structure as measured in a peeling test is 50 N/20 mm or more.

3. The integrated sheet structure according to claim 1, wherein a content ratio of the third binder in the third mixture layer is larger than a content ratio of the second binder in the second mixture layer and a content ratio of the first binder in the first mixture layer.

4. A secondary battery comprising:
the integrated sheet structure according to claim 1;
an electrolyte;
a first current collector; and
a second current collector,
wherein the first current collector is located on a main surface of the first mixture layer, and
the second current collector is located on a main surface of the second mixture layer.

5. The secondary battery according to claim 4, wherein the secondary battery has a negative electrode, a positive electrode, and a separator,
the negative electrode includes the first mixture layer and the first current collector,
the positive electrode includes the second mixture layer and the second current collector, and
the separator is the third mixture layer.

6. An aqueous secondary battery comprising the secondary battery according to claim 4, wherein the electrolyte is an aqueous electrolyte.

7. A battery pack comprising the secondary battery according to claim 4.

8. The battery pack according to claim 7, further comprising:
an external power distribution terminal; and
a protective circuit.

9. The battery pack according to claim 7, wherein the battery pack includes a plurality of the secondary batteries, and the plurality of the secondary batteries are electrically connected in series, in parallel, or in combination of series and parallel.

10. A vehicle comprising the battery pack according to claim 7.

11. The vehicle according to claim 10, wherein the vehicle includes a mechanism configured to convert kinetic energy of the vehicle into regenerative energy.

12. A stationary power supply comprising the battery pack according to claim 7.
